(19) United States
(12) Patent Application Publication
(10) Pub. No.: US 2015/0004571 A1
(43) Pub. Date: Jan. 1, 2015

(54) APPARATUS, SYSTEM, AND METHOD FOR FACILITATING SKILLS TRAINING

(71) Applicant: CommercialTribe, Denver, CO (US)

(72) Inventors: Paul IRONSIDE, Lafayette, CO (US); Nathan SMALLEY, Lafayette, CO (US); Jonathan PALAY, Lafayette, CO (US)

(21) Appl. No.: 14/321,372

(22) Filed: Jul. 1, 2014

Related U.S. Application Data
(60) Provisional application No. 61/841,780, filed on Jul. 1, 2013.
(60) Provisional application No. 61/954,034, filed on Mar. 17, 2014.

(51) Int. Cl. G09B 19/04

(52) U.S. Cl. CPC G09B 19/04
USPC 434/185

(57) ABSTRACT

Non-limiting embodiments of systems and apparatuses are provided in which one or more processors are communicatively coupled to a network. The one or more processors are configured to present to a first user a plurality of exemplary recorded presentations, record a presentation by the first user, and present to a second user the recorded presentation by the first user. The one or more processors are also configured to receive feedback from the second user on the recorded presentation by the first user and present the feedback to the first user. Non-limiting embodiments of processor-readable non-transitory storage mediums and methods performed by the systems, apparatuses, and mediums are also provided.

### CROSS-REFERENCE TO RELATED APPLICATION

The present application claims priority to U.S. Patent Provisional Application No. 61/841,780, filed on Jul. 1, 2013, entitled “Apparatus, System, And Method For Facilitating Skills Training,” and to U.S. Patent Provisional Application No. 61/954,034, filed on Mar. 17, 2014, entitled “Apparatus, System, And Method For Facilitating Skills Training” Both of these provisional applications are incorporated herein by reference in their entirety for all purposes.

### FIELD OF THE DISCLOSURE

In some embodiments, the present disclosure relates generally to an apparatus, system, and method for training users to improve one or more skills. For example, in one implementation, a system facilitates training of sales people to present a sales “pitch,” and in another implementation, the system helps to train a lawyer to present an opening statement before a judge and jury in a litigation.

### BACKGROUND OF THE DISCLOSURE

The ability to present information clearly and persuasively is important in many fields, such as sales, marketing, law, motivational speaking, etc. Periodic training can help professionals and employees in these fields improve and hone their presentation, communication, and persuasion skills.

Traditionally, training of professionals and employees has been done in a classroom or workshop setting, which can require a significant time commitment from both the trainers and trainees. For example, the trainers and trainees must dedicate a significant amount of time to attend the entire training class and to travel to and from the class. Moreover, this traditional approach requires substantial scheduling logistics to ensure that the training place, date, and time are convenient for the trainer and a minimum number of trainees to make the classroom or workshop training session worthwhile from both financial and time-resource perspectives.

Because of these time and financial commitments, as well as the scheduling logistics, traditional training sessions typically only occur sporadically. As a result, the information and skills that the professionals, employees, and other trainees learn during these session often are not retained, not used effectively, and not taught frequently enough.

### SUMMARY OF THE DISCLOSURE

Non-limiting embodiments of systems and apparatuses are provided in which one or more processors are communicatively coupled to a network. The one or more processors are configured to present to a first user a plurality of exemplary recorded presentations, record a presentation by the first user, and present to a second user the recorded presentation by the first user. The one or more processors are also configured to receive feedback from the second user on the recorded presentation by the first user and present the feedback to the first user. Non-limiting embodiments of processor-readable non-transitory storage mediums and methods performed by the systems, apparatuses, and mediums are also provided. Other embodiments besides these embodiments are also provided.

### BRIEF DESCRIPTION OF THE DRAWINGS

Aspects of illustrative, non-limiting embodiments will become more apparent by describing them in detail with reference to the attached drawings in which:

FIG. 1 illustrates a non-limiting example of a method for facilitating a number of activities to help engage and train a user in accordance with some embodiments of the disclosure;

FIG. 2 illustrates a non-limiting example of a method by which a presentation may be made available to, and accessed by, a user in accordance with some embodiments of the disclosure;

FIG. 3 illustrates a non-limiting example of a search screen for searching for presentations in accordance with some embodiments of the disclosure;

FIG. 4 illustrates a non-limiting example of a playback screen for viewing presentations in accordance with some embodiments of the disclosure;

FIG. 5 illustrates a non-limiting example of a method by which a user records a presentation, submits the presentation for review, and receives feedback for the presentation in accordance with some embodiments of the disclosure;

FIG. 6 illustrates a non-limiting example of a recording screen for recording presentations in accordance with some embodiments of the disclosure;

FIG. 7 illustrates a non-limiting example of a playback screen for viewing presentations in accordance with some embodiments of the disclosure;

FIG. 8 illustrates a non-limiting example of a practice screen for recording presentations in accordance with some embodiments of the disclosure;

FIG. 9 illustrates a non-limiting example of a “My Performance—Rep View” screen in accordance with some embodiments of the disclosure;

FIG. 10 illustrates a non-limiting example of a “My Performance—Manager View” screen in accordance with some embodiments of the disclosure;

FIG. 11 illustrates a non-limiting example of a “Announcements and Notifications Page” in accordance with some embodiments of the disclosure;

FIG. 12 illustrates a non-limiting example of a “Best Practices Page” in accordance with some embodiments of the disclosure;

FIG. 13 illustrates a non-limiting example of a “Playback Page” in accordance with some embodiments of the disclosure;

FIG. 14 illustrates a non-limiting example of a “Record Page” for recording presentations in accordance with some embodiments of the disclosure;

FIG. 15 illustrates a non-limiting example of a “My Workspace Page” in accordance with some embodiments of the disclosure;

FIG. 16 illustrates a non-limiting example of a “Manager Workspace Page” in accordance with some embodiments of the disclosure; and

FIG. 17 illustrates a non-limiting example of a “Playback Page” in accordance with some embodiments of the disclosure;

### DESCRIPTION OF THE DISCLOSURE

The present disclosure describes illustrative, non-limiting embodiments of systems, apparatuses, and methods that can be used facilitate ongoing training of communication, presentation, and persuasion skills. In one implementation, one or more software applications are provided to users within a given enterprise to collaborate with peers, trainers, and management in order to increase their skills by both watching presentations by others and recording their own presentations for evaluation by others.

In one non-limiting embodiment, an original equipment manufacturer (“OEM”) (or an original service provider) may work with channel partners or value added resellers (“VARs”) to distribute and sell its products (or services). Moreover, the OEM (or original service provider) may own or operate a training system or apparatus for selling its products (or services) in accordance with the embodiment. In this situation, the user of the training system or apparatus may be an employee or contactor of the channel partner, and the person responsible for ensuring that the channel partner employee or contractor is adequately trained via the system or apparatus may be an employee of the OEM (or original service provider). In this case, the software application(s), user interfaces, and other aspects of the system or apparatus may be modified for the particular channel partner. For example, since the channel partner is a “third party” with respect to the OEM (or original service provider), the OEM (or original service provider) likely has confidential information and/or training methods that it does not want to disclose to the channel partner. Therefore, the OEM (or original service provider) may modify the content that its system or apparatus ordinarily would disclose to its own employees, and how it would typically interface with its own employees, so that it discloses less or different information to, and interfaces differently with, the channel partner employees and contractors. Of course, the same or similar modifications may be made if the OEM (or original service provider) leased or lent its system or apparatus to the channel partner and the person responsible for training the channel partner employees and contractors is also an employee of the channel partner. Moreover, user interfaces and other aspects of the system and apparatus may be changed so that it reflects the “rebranded” products and services and other aspects of the channel partners. Also, the operational flow of the OEM system or apparatus may be modified to better adapt to the internal workflow within the channel partner.

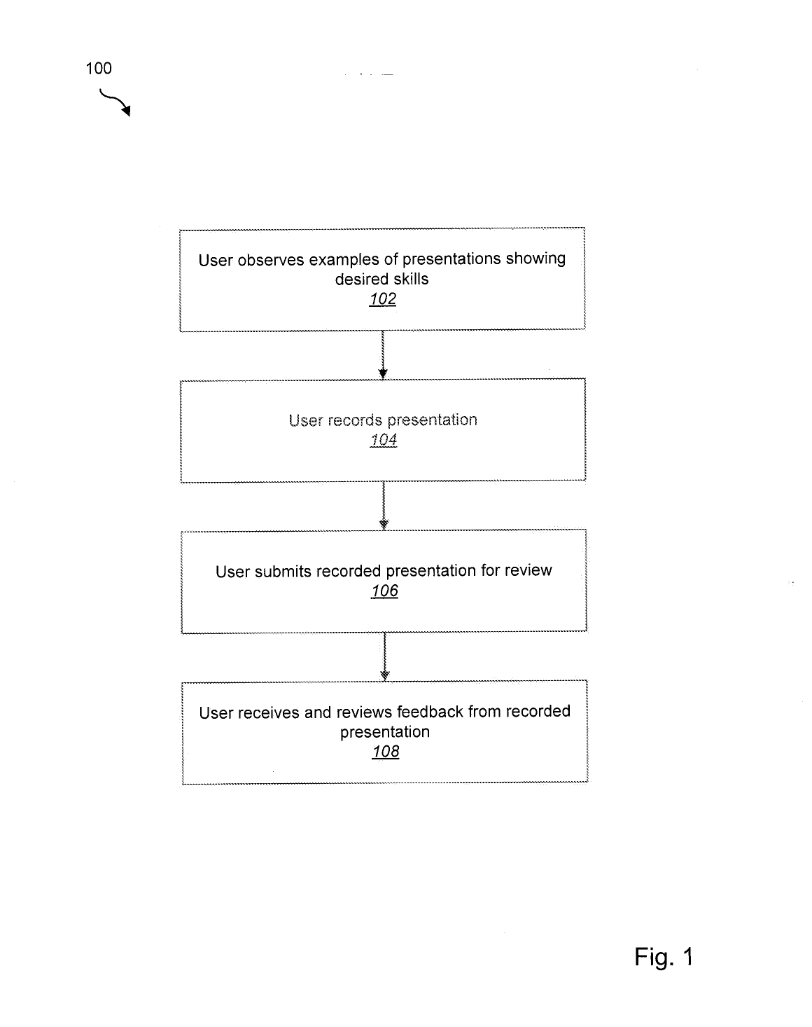

FIG. 1 shows an example of a flowchart of a non-limiting method 100 for facilitating a number of activities to help engage and train a user. Upon reading the present application, one skilled in the art will understand that all of the steps of the method shown in FIG. 1 (as well as other methods described in the disclosure) do not need to be performed and that other steps, besides those disclosed, additionally can be performed. Furthermore, the steps of the various disclosed methods do not necessarily need to be performed in the order in which they are described and depicted, and many of the steps can be performed simultaneously.

Per the method 100 shown in FIG. 1, as user who would like to improve his or her skills in a particular area observes examples of presentations showing the desired skills (step 102). For example, the user may observe a video recording of others presenting information about a certain topic or material. Then, after observing one or more presentations, the user may record his or her own attempt (or multiple attempts) at presenting the material (step 104). After the user is satisfied with his or her attempt(s), he or she may submit the recorded presentation(s) for others to review (step 106). Finally, after others review the user's presentation(s), they may provide feedback and constructive criticism for the user to review (step 108). By reviewing this feedback, the user will be able to improve his or her presentation skills.

In addition, based on (1) the user's experience, (2) the user's position within a company or organization, (3) how many training sessions the user has successfully completed, (4) how many training sessions the user attempted, but failed, (5) the user's prior or current use of the system, and/or (6) etc., the system may train the user with a “progressive curriculum.” In one embodiment of the progressive curriculum, the system selects multiple topics to incrementally train the user so that he or she can improve his or her skills on various subjects, skill elements, and/or topics to become proficient at a more global skill set. This progressive curriculum is analogous to a college student taking courses to obtain a business degree. In this analogy, the student would take individual mathematics, marketing, economics, and other courses. After successfully completing a minimum number of college courses, the student would be able to graduate with his or her business degree.

Similarly, in the embodiment implementing the progressive curriculum, the system can select various topics or categories for training the user. Once the user successfully completes the training on one topic or category, the system may select another topic or category. After successfully completing a minimum number of training sessions for the various topics or categories, the user may become certified for a more global skill set. Non-limiting examples of more global skill sets include the skill set needed for the user's next promotion within a company, the skill set needed for a sales representative to attend a sales pitch for a potential customer without being accompanied by a manager or a more senior employee, etc.

In addition, in this progressive curriculum embodiment, the system may automatically select topics or categories for training the user. Alternatively, the user's manager, supervisor, etc. may select the topics or categories for training the user. Still alternatively, the user may be able to select topics or categories from a predetermined set of topics or categories relating to the more global skill set that the user is trying to obtain. Of course, the embodiment may use some combination of the above methods for selecting the various topics or categories.

More detailed, non-limiting examples of the steps 102, 104, 106, and 108 of the method 100 are described below. Moreover, in some implementations, an integrated software solution is provided which allows multiple users of a computer network or system to engage in any or all of the above steps, as further explained below.

1. Observe Examples of Presentations which Show Desired Skills (FIG. 1 (Step 102)).

In one example, presentations may be stored in a database and accessed by a user who would like to improve his or her presentation skills. The presentations may be stored in a database on an Internet server, in a “cloud-type” arrangement, on a local area network (“LAN”) of a company or other organization, or locally on the user's desktop. One of ordinary skill in the art, upon reading the present disclosure, will understand that there are many types of databases in which the presentations may be stored. Furthermore, the presentations may be stored on many different types of media, such as a solid state memory device (e.g. flash memory, random access memory, read only memory, etc.), a magnetic or optical disc, magnetic tape, etc.

Moreover, one of ordinary skill in the art, upon reading the present disclosure, will understand that there are many different ways that the user can access the presentations. In the example in which the presentations are stored in a database on an Internet server or in the “cloud,” one or more software applications may enable a user to use a user terminal (e.g., a desktop, laptop, smartphone, tablet (e.g., an iPad), mobile device, etc.) to log onto a website capable of accessing the database to retrieve a presentation. After retrieving the presentation, the application(s) may output the presentation on the user terminal so that the user can view and/or listen to it.

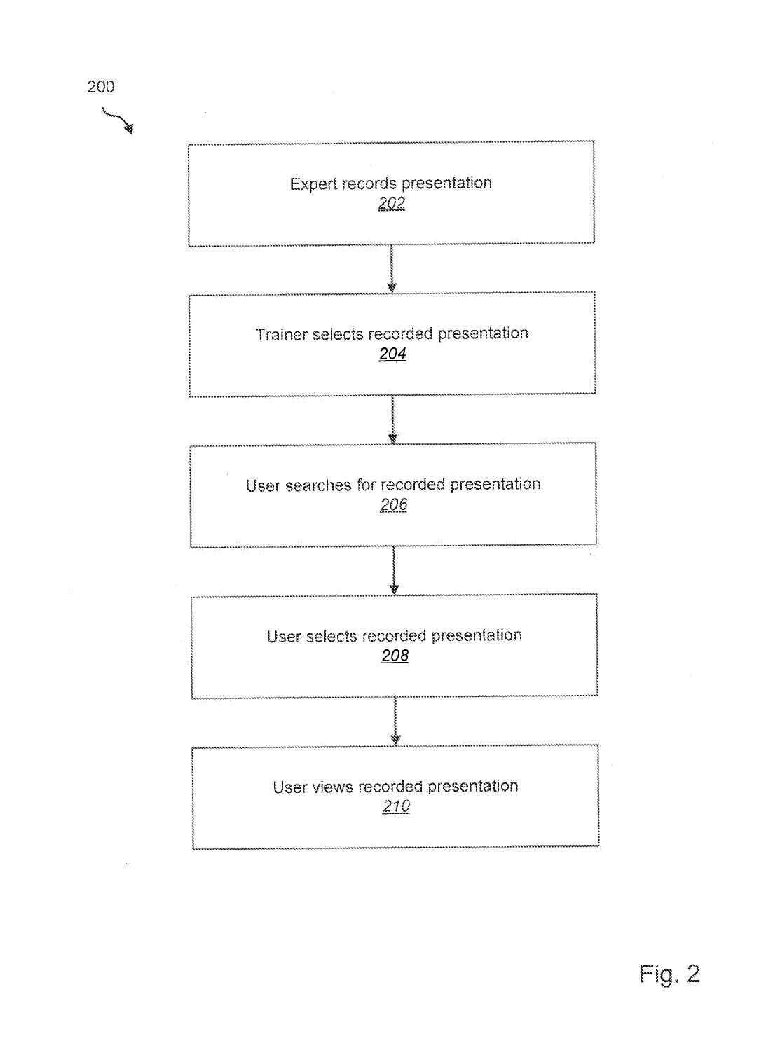

FIG. 2 is a non-limiting example of a flowchart illustrating a method 200 by which a presentation may be made available to, and accessed by, a user.

In some implementations, an exemplary presentation for use in training is created by someone with expertise in the skills to be trained (step 202). Some exemplary presentations may be specifically recorded for use in the system. Other exemplary presentations may be previous recordings made for other purposes that are uploaded to the system as examples. The system may host a large number of different training presentations recorded and stored to train a variety of different skills.

In some embodiments, the presentations are selected or created by a trainer (step 204). The trainer can be the user's employer, the user's manager, a user, peer user, an outside consultant of the company or firm where the user works, an expert or well-regarded person in the field of the user's profession or employment, an individual tasked with overseeing the user's training, etc. The trainer can select the presentations from among existing presentations based on his subjective assessment of the presentations, based on how peers or others have ranked the presentations, and/or based on which individuals have given the presentations. For instance, in the legal field, the trainer may select a recording of a seasoned lawyer giving a very good opening statement in a famous case as one of the presentations on “How To Do Great Opening Statements.” In another example, an employer may select a recording of a persuasive “sales pitch” of a senior salesperson of a company who used the pitch to convince a large customer to buy a substantial amount of goods or services from the company. Of course, the presentations do not have to correspond to actual opening statements, sales pitches, etc. Instead, the presentations can be “mock” presentations in which actors (or senior employees, managers, professionals, etc.) give a presentation in a pretend setting for educational and training purposes. In addition, the presentation does not need to be associated to any content-related element and could simply be a video recording.

In addition, the presentations can be performed by the user's peers in a company or organization. For example, in a sales organization, presentations or sales pitches of the user's peers, which have received high ranks or good feedback, may be selected or made available to the user.

The presentations may also be categorized and indexed so that the user can easily search for a desired presentation (step 206). For instance, a website may contain a hierarchical tree of hyperlinks that enables a user to find a list of relevant presentations. In one embodiment, at the highest level, an initial webpage may display a list of hyperlinks corresponding to broad categories of presentations, such as “law,” “sales,” “marketing,” “engineering,” etc. If the user selects a hyperlink corresponding to one of these categories (e.g., “law”), a lower level webpage may be displayed showing hyperlinks of various subcategories, such as “trial arguments,” “depositions,” “client pitches,” etc. Again, if the user selects “trial arguments,” yet another webpage may be displayed containing hyperlinks corresponding to subcategories, such as “opening statements,” “direct examinations,” “cross examinations,” “closing statements,” etc. Finally, if the user selects the hyperlink corresponding to “opening statements,” a list of hyperlinks for available presentations of lawyers (and/or actors, etc.) conducting opening statements is shown. This list may also rank the presentations based on various criteria, such as how other users, trainers, etc. have ranked the presentations, how successful the presentations were, how recent the presentations are, or in accordance with “hashtags” (described in more detail below), etc.

In addition to selecting presentations by clicking through hyperlinks on webpages, or other displayed pages or screens, one of ordinary skill in the art, upon reading the specification, will understand that software applications can display the hierarchical tree of categories and subcategories without using hyperlinks and/or webpages. Furthermore, other methods of conveying this information to the user are available as well.

For example, the software application(s) may provide a template that allows the user to enter various search criteria, such as one or more categories and/or sub-categories of a desired presentation, a minimum ranking of the presentation, information about when the presentation was given, etc. After entering the search criteria, the user can instruct the application(s) to search for the presentation, and in response, the application(s) may provide a list of presentations that satisfy the criteria. Moreover, instead of, or in addition to, using a template, the application(s) may allow a user to search for presentations by entering Boolean search terms and/or by simply entering key words, such as when a user conducts an Internet search via an browser like Google™.

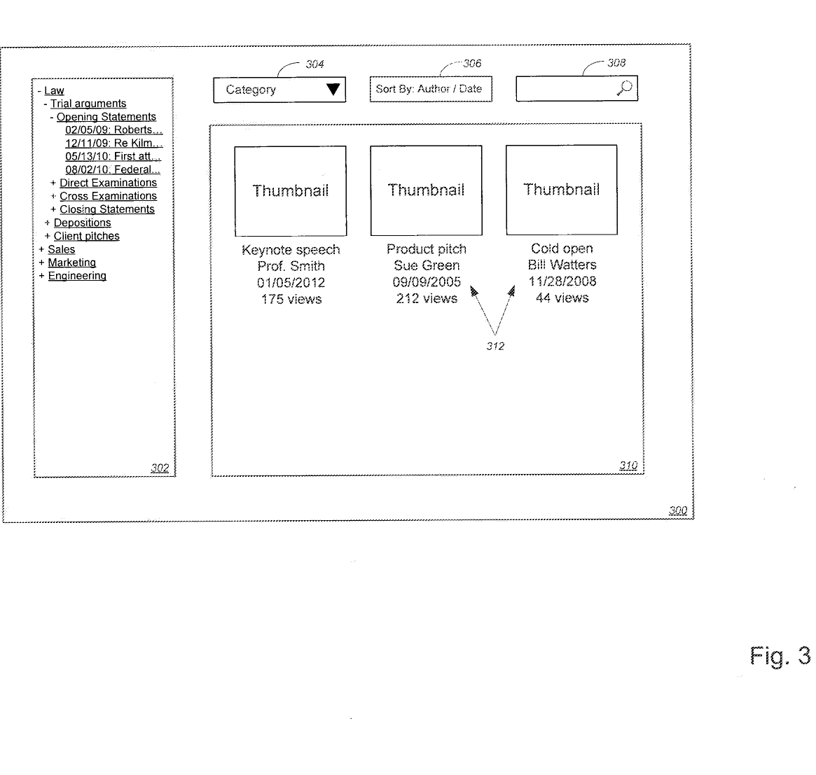

An exemplary search screen 300 in accordance with some embodiments of the present disclosure is illustrated as FIG. 3. Here, a navigation bar 302 with a hierarchical index is presented on the left side of the page 300. As shown, the navigation bar 302 contains the following, high-level categories: Law, Sales, Marketing, and Engineering. Of course, the illustrated categories are merely exemplary, and any number and types of categories may be included.

Continuing with the example, if the user selects the “Law” category, the following subcategories may be displayed: Trial Arguments, Depositions, and Client Pitches. If the user decides to select the “Trial Arguments” subcategory, the following subcategories may be displayed: Opening Statements, Direct Examinations, Cross Examinations, and Closing Statements. If the user selects the “Opening Statements” subcategory, the recordings of actual or mock opening statements are displayed and may be selected from the navigation bar 302. As with the categories, the illustrated subcategories are merely exemplary, and any number and types of subcategories may be included.

In addition to selecting categories and subcategories, in one embodiment, the system may allow unstructured and adhoc tagging elements to be assigned to presentations (and accompanying visual aids and other information described below). These tagging elements are referred to as “hashtags.” While, in some embodiments, the category and subcategories corresponding to a presentation are predetermined or fixed, a hashtag is a category or description of a presentation that can be assigned to a presentation “on the fly.” Once the hashtag is assigned to a presentation, a user can search for the presentation byt entering the hashtag via, for example, a keyword search (described in more detail below).

As an example of a hashtag, assume that a company has set up a system, in accordance with a non-limiting embodiment, to have a category called “Corporate Pitch” and subcategories called “Intro,” “The Problem,” “Our Solution,” and “Closing,” and presentations may be classified in accordance with this framework. Now, assume that a user has created a presentation (as described in more detail below) that does not fit within any of the available and established categories and subcategories. In this instance, the user can assign a hashtag called “#NotCompliant” to the presentation. Once the hashtag has been assigned to the presentation, the user, other users, and the system can find and/or index the presentation based on the assigned hashtag.

For example, the user (or manager or trainer) may create a presentation (as described in more detail below) relating to a scenario in which the user (or manager or trainer) attempted to sell a product to a customer and in which the customer initially refused to buy the product by saying that “The company is not compliant so we can't buy your product.” In a social, organic, or forced way, other users may respond to the customer's objection and provide advice on how they would respond to the objection. The hashtag is then tracked to find out who is searching, what activity is it causing and generating, and what content is associated with it. Alternatively, if the user (or manager or trainer) involved in the exchange with the customer actually had a successful response that ultimately persuaded the customer to buy the product, the user could record such a response in the presentation. Then, other users who encountered a similar exchange with a customer could search for the user's successful presentation by searching for the ““#NotCompliant” hashtag.

Moreover, in addition to, or instead of, listing the recordings of the opening statements in the navigation bar 302, the search results (e.g., opening statements) may be identified in a search results window 310. For instance, in the window 310, each opening statement may be identified with a title, date, textual description, and/or other information. Additionally or alternatively, a “thumbnail” corresponding to the video of, or other identifying information for, each opening statement may be displayed in the window 310.

In addition, in one embodiment, the system may keep track of the characteristics and profile of the users accessing the system, and the categories, subcategories, search results, etc. relating to the search described above may be adapted to the particular user accessing the system. For example, if the user is a senior lawyer with a lot of experience (as opposed to a first year associate), a larger number of categories/subcategories and/or categories/subcategories relating to more complicated areas of the law may be available to the senior lawyer when he or she is searching for presentations. Additionally or alternatively, the system may evaluate the user profile and characteristics for the senior lawyer and first year associate, and based on the profile and characteristics, the system may return different search results for the same search conducted by both attorneys. Namely, in this example, the search results displayed for the senior lawyer may deal with more complex legal issues than the search results displayed for the first year associate.

Similarly, the user profile and characteristics may include other types of information, such as how long the user has been using the system. If the user has been using the system for a relatively long period of time and/or has demonstrated that he or she can proficiently use the system, the system may make more complex features and options available to the user. On the other hand, if the user has not been using the system for a long period of time and/or if the system detects that the user is not yet proficient as using one or more aspects of the system, the system may only provide the user with rudimentary or basic system features and options. One illustrative, non-limiting example of how the system determines whether a user is (or has become) proficient at using one or more aspects of the system is to keep track of how long the user takes to perform a particular task. For example, if the user takes a long time to maneuver through the categories and subcategories, or enters imprecise Boolean search strings or keywords (discussed below), to obtain search results, the system may consider the user to an inexperienced user for the searching feature of the system. One the other hand, if the user can quickly peruse through the categories and subcategories and enter precise, and efficient, search strings and keywords, the system may consider the user to be experienced.

The system's assessment of users' proficiency, of course, if not limited to assessing how well users can conduct searches. In one illustrative embodiment, the system can assess how proficient a user is at performing many or all of its various features and can taylor its individual features and available options for each user based on his or her proficiency with each feature and option. Moreover, as alluded to above, the system can adapt its features and available options based on other user characteristics, such as the amount of experience the user has in the field in which he or she is being trained, how much success the user has had in the field, the type of feedback that trainers or reviewers have provided to the user (discussed in more detail below), etc. In addition, this information may be stored as “metadata” in the user's profile.

Upon reading the present specification, one skilled in the art with understand that other methods of maneuvering through categories and subcategories of information, searching for information, and displaying search results with the information can be used. For instance, as shown in FIG. 3, the top of the page 300 contains a category dropdown box 304, and the user can manipulate the dropdown box 304 to select categories and subcategories. Additionally or alternatively, the page 300 may include multiple dropdown boxes, and the user can select a desired category via a first dropdown box and can further narrow his or her search by selecting one or more subcategories via one or more additional dropdown boxes.

Additionally or alternatively, as noted above, the user can enter keywords or other search criteria, such as Boolean searches, to obtain the various search results 312. For example, the user can enter Boolean searches or keywords via a search window 308.

FIG. 3 also shows a “sort” dropdown box 306, and the user can manipulate this dropdown box 306 to sort the obtained search results 312 according to one or more criteria. For example, the results 312 can be sorted by the author of the material, the date of the material, how many other users have previously viewed the material, how other users have ranked the material, etc. As discussed above, the criteria contained in the “sort” dropdown box 306 may also include recommendations based on the user profile information, the user's experience with using the system, and/or other related meta data that is specifically associated with the user conducting the search. In some implementations, this user profile information alters how the sorting operations and filters behave. Additionally or alternatively, the criteria contained in the dropdown box 306 may not change based on the user profile information, the user's experience with using the system, and/or other related meta data and instead, the sorting or search results that are ultimately displayed are selected and altered based on the user profile information, the user's experience with using the system, and/or other related meta data.

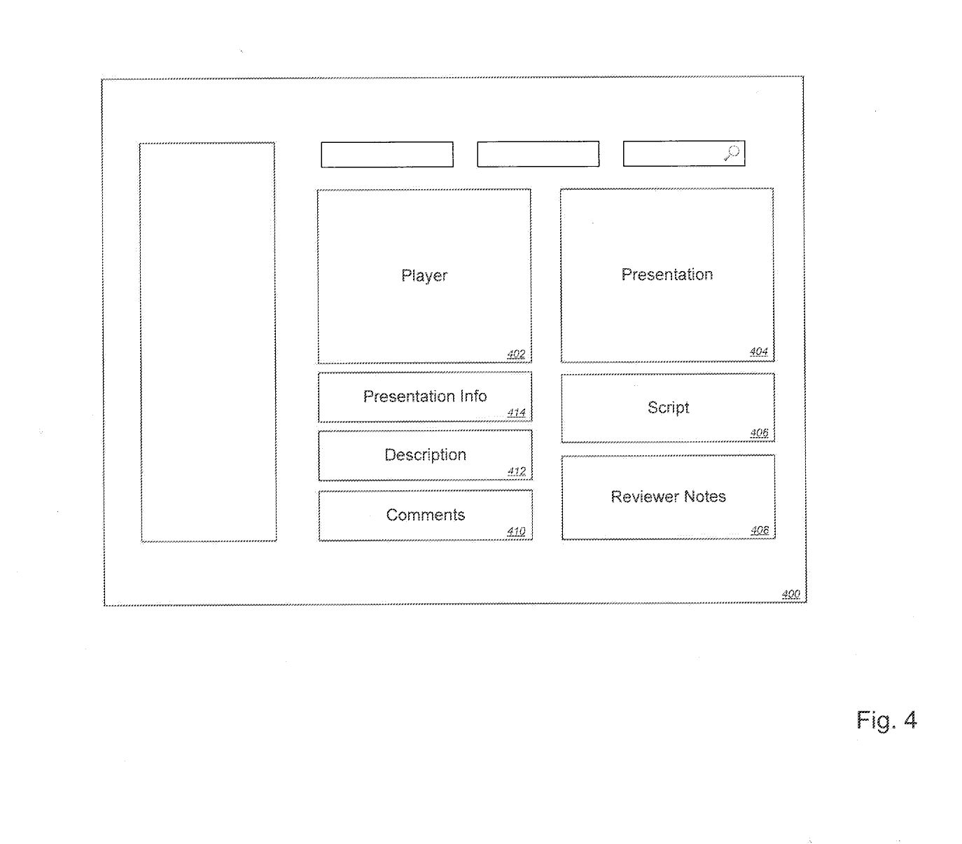

After displaying the search results 312, the user can select one of the results 312 to observe (step 208). In one non-limiting implementation, the system may display the presentation corresponding to the selected search result 312 on a playback screen 400 illustrated in FIG. 4 (step 210).

As shown, the exemplary playback screen 400 may include a video window 402 containing a video (and/or audio) recording of an expert or well-regarded person in the relevant field delivering the presentation. In some implementations, the playback screen 400 may also include a presentation window 404 that displays a visual aspect or component of the presentation that the expert or well-regarded person is delivering. For example, if the expert is a lawyer delivering an opening statement with PowerPoint slides, the video window 402 may display a video recording of the expert delivering the presentation to a judge or jury, and the presentation window 404 may display the various PowerPoint slides accompanying the presentation.

If the expert or well-regarded person is delivering his or her presentation based on a script, the script may be shown in a script window 406. Continuing with the example above, the text may be keyed to the PowerPoint slides that the lawyer is using during the oral argument. Moreover, the script may be displayed on a “scrolling” basis as the expert or well-regarded person is presenting so that the script window 406 gives the appearance of a “teleprompter.”

In certain embodiments, a user can select to view presentations made by others who are not experts or well-regarded in the relevant field. For example, the user may select to view presentation may by the user's peers or colleagues. In this scenario, the playback screen 400 may include a “comments” window 410 that allows the user to comment on the presentation. In addition, the “comments” window 410 may allow multiple users to add comments on the same presentation such that a user currently viewing the presentation can comment on the presentation, as well as review the comments made by other users that previously commented on the presentation. These user comments may be saved along with the presentation so that they are available when future users select and view the presentation.

Similarly, the playback screen 400 may have a “reviewer notes” window 408 for a user's presentation. This window 408 includes the constructive feedback, comments, and notes of one or more reviewers (e.g., trainers, supervisors, or colleagues of the user who recorded the presentation) regarding the presentation. When others view the presentation of a particular user, they can review the feedback and comments that the reviewers had about the presentation. Accordingly, users who review another peer's or college's presentation can likewise benefit from the reviewers' feedback.

The playback screen 400 may also contain a presentation information window 414 that includes information about the presentation, such as the title, date, category, etc. of the presentation. The screen 400 may further include a decryption window 412 that contains additional decryption or explanation about the presentation. For example, if the presentation relates to a lawyer delivering an opening statement in a litigation, the description window 412 may contain information about the parties to the lawsuit, the cause of action asserted in the lawsuit, and an overview of the issues in the case.

The playback screen may also include statistics and metrics based on how this information was used by other users, and by other more relevant descriptions based on the users profile. For example, different metrics and information may be displayed in the playback screen 400 based on the user's position within a company, how many training sessions he or she has successfully completed, how many times the user has attempted, but failed, a particular training session, etc. Some illustrative examples of the different metrics and information that may be displayed on the playback screen 400 are as follows. If the presentation being viewed (or reviewed) relates to the closing of a sale, the playback screen 400 may display information noting that the user recently closed five deals similar to the deal set forth in the presentation. This may be a relevancy or contextual metric/information. Moreover, if the user shared this presentation with 15 other users, and 10 of these 15 users shared the presentation with yet other users, this information may be displayed. This may be a metric or information about how well known the content is within an organization or a group of users. Other metrics and information include information regarding how often presentations recorded by a particular user are viewed, which may indicate how well known or “popular” the particular user is. Moreover, information or metrics about how often a particular user's presentations are certified (or what percentage of the particular user's presentations are certified) by, for example, a user's peer group may be displayed. This type of information or metric imparts peer pressure or voyeuristic influences on other users.

### 2. Record the User's Own Attempt(s) at Presenting Material (FIG. 1 (Step 104)).

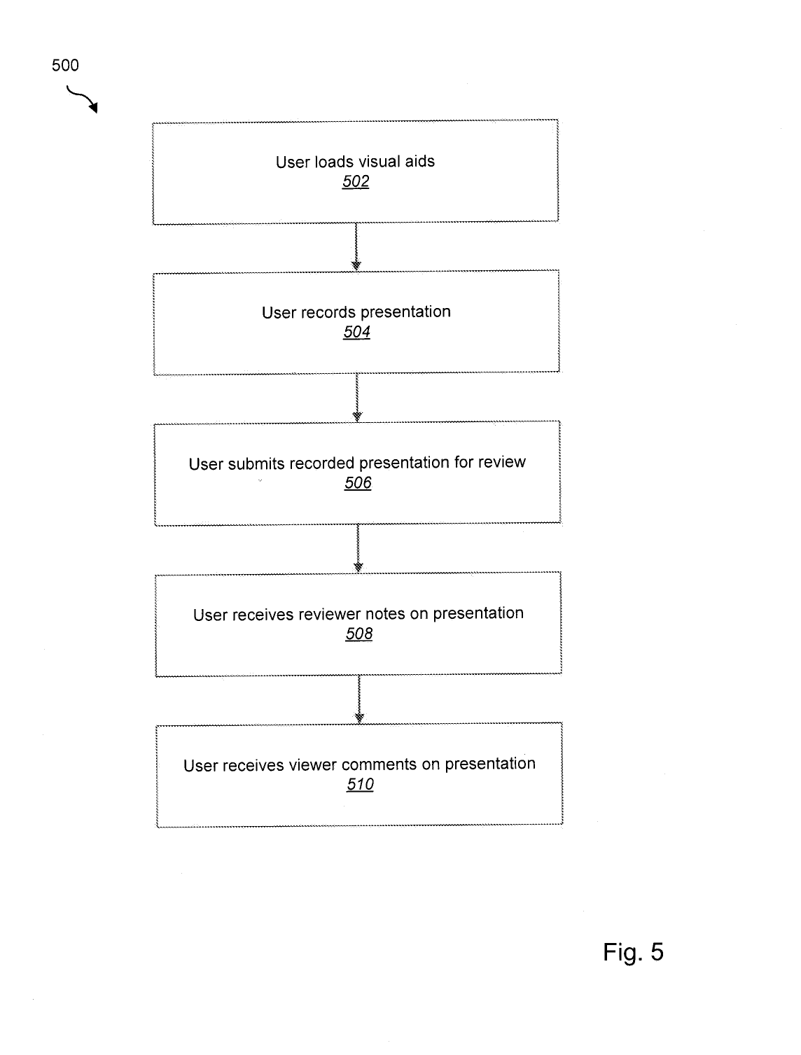

After the user views the selected presentation one or more times, the software application(s) may allow the user to record one or more of his or her own attempts at a giving the presentation (e.g., the same or a similar presentation), as illustrated by the exemplary method 500 depicted by the flowchart shown in FIG. 5. The application(s) may allow the user to start, stop, pause, erase, and restart the recording of the user's presentation. In addition, the application(s) may provide links or other access to visual aids (e.g., PowerPoint presentations) or other elements (e.g., a presentation script or outline) to assist the user in recording his or her presentation. These visual aids and other elements may be displayed on the screen of the user terminal while the terminal's external or built-in video camera and microphone record the presentation. Of course, the user can record an attempt at a giving a presentation without previously searching for and viewing recorded presentations of other users or experts.

The user terminal may also display a video image of the user giving the presentation as the user is actually presenting it in order to provide the user with immediate feedback about how the user looks while presenting. This video image may be displayed instead of the visual aids and elements or in addition to these aids and elements, such as via a split-screen display or in a separate window on the display.

In one embodiment, the user's video presentation is synchronized with the visual aids or other elements (e.g., PowerPoint presentation, script, outline, etc.). The software application can automatically accomplish this synchronization by using various techniques, such as voice recognition software that recognizes the user's voice and advances the PowerPoint presentation slides, pages of the script, or pages of the outline accordingly. Moreover, the script or outline may be advanced by scrolling it on a line-by-line basis, similarly to a teleprompter. On the other hand, user may manually advance the visual aids or other elements, such as by clicking a mouse or selecting a particular “advance” icon on the user interface.

In one variation, the application(s) may allow the user to choose whether to record a presentation with or without the help of a displayed presentation script or outline. For example, while a user is initially practicing the presentation, he or she may choose to record the presentation with the script or outline in order to become familiar with the subject matter and flow of the presentation. As the user continues to practice the presentation and becomes more comfortable with it, he or she may choose to record the presentation without the script or outline in order to more closely simulate a real-world scenario of giving the presentation to a customer or client.

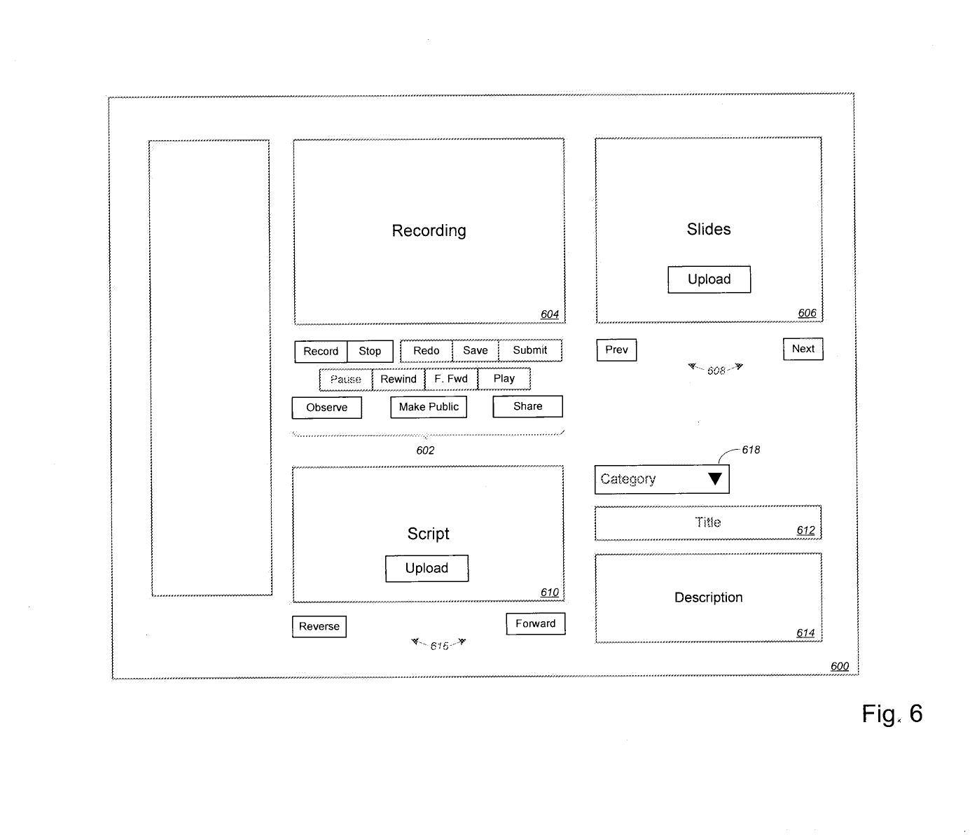

In some implementations, the user may first load one or more visual aids, such as PowerPoint slides, a script or outline for the presentation, etc. into the system (FIG. 5 (step 502)). FIG. 6 shows an example of a non-limiting recording screen 600 that provides an interface to assist the user with recording his or her presentation. As shown, the screen contains one or more visual aid windows 606 and 610 to enable the user to upload one or more visual aids accompanying the presentation. For instance, the user may upload PowerPoint slides into a first visual aid window 606 by selecting the “upload” button in the window 606 (and possibly inputting additional commands to search for and select the appropriate file containing the PowerPoint slides). Similarly, the user may upload a script or outline for the presentation into a second visual aid window 610 by selecting the “upload” button in the window 610 (and possibly inputting additional commands to search for and select the file containing the script or outline). As explained above, various techniques can be used to synchronize the slides, script, and outline with the user's presentation as he or she presents it.

In one implementation in which the user can manually advance the slides, control buttons 608, such as “Previous” and “Next” buttons, may be provided. In this scenario, the user can advance to the next PowerPoint slide and return to the previous slide by selecting the “Next” and “Previous” buttons, respectively. Similarly, in an embodiment in which the user can manually advance the script or outline, control buttons 616, such as “Reverse” and “Forward” buttons, may be provided. The user can advance to the next portion or the script or outline and return to the previous portion by selecting the “Forward” and “Reverse” buttons, respectively.

If both a set of PowerPoint slides and a script or outline accompany the presentation, both sets of control buttons 608 and 616 may not be necessary. For example, in this scenario, the just the control buttons 608 (or just the buttons 616) may be used to simultaneously advance both the slides and the script or outline. This implementation may be convenient, for example, if the script or outline coincides, and is synchronized, with the slides because the user would not have to manually hit multiple buttons to advance the script/outline and the slides.

In some embodiments, the user's terminal has a microphone and video camera, which the user can use to record himself or herself delivering the presentation (FIG. 5 (step 504)). As shown in FIG. 6, the recording screen 600 may include a recording window 604 that shows the video images of the user delivering the presentation as he or she is presenting it. The user can start, stop, and control the recording of the presentation by manipulating a set of recording buttons 620, which include, for example, “Record,” “Play,” “Stop,” “Pause,” “Rewind,” “Fast Forward,” “Redo,” “Save,” and “Submit” buttons. The user can begin recording his or her presentation by pressing the “Record” button. The user can also pause or stop recording the presentation by selecting the “Pause” or “Stop” buttons. Moreover, if the user would like to re-record or edit all or a portion of the presentation that has been recorded, he or she can select the “Pause” or “Stop” button and then select the “Rewind” button to rewind the presentation to the point from which the user would like to re-record it. The user can also select the “Redo” button to discard the prior recorded version and begin recording it again “from scratch.” The user can also review the entire presentation or desired portions of the presentation by appropriately manipulating the “Pause,” “Stop,” “Rewind,” “Fast Forward,” and “Play” buttons.

As shown in FIG. 6, the set of recording buttons 620 may also have “Observe,” “Make Public,” and “Share” buttons. The “Observe” button allows the user to review a presentation recorded by an expert or well-regarded person in the relevant field delivering the presentation. For example, while the user is recording his or her attempt at the presentation, he or she may realize that reviewing an example how an expert delivered a portion of presentation would be helpful before continuing to record the remainder of his or her own presentation. In this instance, selecting the “Observe” button enables the user to watch all or a portion of the expert's presentation.

In one embodiment, selecting the “Observe” button causes the expert's video to be displayed in the recording window 604 in FIG. 6. In addition, the visual aids, script, and/or outline that the expert used in the presentation may be shown in the visual aids window 606 and/or window 610. Alternatively, selecting the “Observe” button may display windows in addition to the recording and visual aids windows 604, 606, and 610 so that the expert's presentation and visual aids can be displayed simultaneously with the information currently being displayed in the windows 604, 606, and 610. In another implementation, selecting the “Observe” button may display the playback screen 400 shown in FIG. 4 and may display the expert's video presentation in the video window 402 and accompanying visual aids in the windows 404 and 406.

Also, in one example, when the user is in the process of recording his or her presentation and presses the “Observe” button, the last video presentation that the user reviewed via the playback screen 400 before attempting to record his or her own presentation is displayed. In another example, after selecting the “Observe” button, the user is able to search for a new and different presentation as set forth above.

In some embodiments, a particular user's presentation is not available to be searched for and viewed by other users, unless the particular user inputs a command authorizing others to do so. In the example, shown in FIG. 6, the user can input such a command by selecting the “Make Public” button. After selecting the button, the user's presentation will be available for others to discover and watch.

Some implementations of the system may include a “Share” button to allow the user to actively share his or her presentation with others. For example, when the user selects the “Share” button, he or she may be able to choose an individual (e.g., another user, trainee, manager, etc.) to review the presentation before or after it is officially “submitted” for review (as described below). Moreover, in addition to sharing the presentation with an individual, the user may be able to share it with a group of people.

After the user records all or part of the presentation, he or she can select the “Save” button so that he or she can review, or resume recording, the presentation at a later time. If the user is satisfied with the presentation, he or she can select the “Submit” button to have the presentation reviewed by others (FIG. 5 (step 506)), as set forth in the non-limiting examples below.

The recording screen 600 also may also enable the user to categorize and/or provide additional information relating to his or her presentation. For example, as shown in FIG. 6, a category dropdown box 618 is provided. The user can manipulate the dropdown box 618 and select an appropriate category for the presentation. Moreover, one or more subcategory boxes (not shown) may be included to allow the user to further refine the categorization of the presentation by selecting one or more subcategories. Instead of choosing a predetermined category and/or one or more subcategories from dropdown boxes, in one embodiment, the user can categorize the presentation by typing in a category and/or subcategories.

The screen 600 may also have a title window 612 in which the user can enter the title of his or her presentation. A description window 614 may also be included which allows the user to provide additional explanations or descriptions relating to the presentation. In some implementations, the category, subcategories, title, and/or descriptions/explanations are associated with the presentation when it is saved and are forwarded along when the user submits the presentation for review by others.

Many of the examples above relate to a user recording an attempt to deliver a presentation to improve his or her skills after the user reviews an example or a “model” presentation delivered by an expert or well-regarded person in the field, an experienced manager or senior sales representative, etc. However, in one embodiment, the recording screen 600 is not limited only to assist with training a user and instead, can be used by an expert or well-regarded person in the field, an experienced manager or senior sales representative, etc. to create the “model” presentation in the first place. In this scenario, the person creating the model does not have to search for and observe examples of presentations showing any particular skills, as described above in conjunction step 102 of FIG. 1. Instead, the person can directly access the recording screen 600 to record the “model” presentation, along with any visual aids.

In yet another embodiment, the application(s) may create an even more realistic presentation environment. For example, if the user is a sales representative, before the user records the presentation, the user terminal may initially play a video of a potential customer or client asking a particular question. For instance, the potential customer may randomly ask a question or make a comment, such as one of the following:
“Can you tell me a little bit about you organization?”;
“Given our poor earnings announcement, our department isn't funding any new initiatives today—we just don't have the budget.”;
“What are the three key takeaways that you would like me to know about your new product?;
Etc.

In addition to being used in the scenario in which the user is a sales representative in which a potential customer or client asks a question, the system can be used in other scenarios. For instance, in a non-limiting implementation, the user could be candidate interviewing for an employment position or for a promotion, and the video may include a potential employer or manager asking an interview-related question.

In one embodiment, after the video of the potential customer, client, or interviewee randomly asks a question or makes a comment, the user terminal prompts the user to record his or her presentation, pitch, etc. in response to the question or comment. In this way, the user is further trained to quickly think on his or her feet and respond appropriately, persuasively, and confidently to a random question. This interaction more closely mimics actual sales or other interactions and better prepares the user for real-world scenarios. Furthermore, instead of randomly playing the video of the customer or client asking a question or making a comment, the trainer may preselect a video containing a desired question or comment, and the application(s) may not disclose the question or comment to the user prior to playing the video for the user.

In one implementation, the user can select whether he or she would like to record a predetermined presentation or would like to record an answer to a random question or comment. Moreover, in responding to the video playback of a customer's or client's question or comment, the application(s) may set a maximum time period (e.g., 90 seconds) for the user to respond. This way, the application(s) will train the user to be clear, concise, and “to the point,” as well as being able to think quickly.

In certain embodiments, the presentation may comprise a wide variety and types of multi-media, such as audio only, audio and video, an animated series of slides, and/or a screen capture walkthrough. In some implementations, the presentation is bound and synchronized to the recorded or playing video of the user through time. In one example, a video presentation may be four minutes in length. Initially, the video presentation plays for a few seconds and a person or voice on the video asks a question or presents an opportunistic pause in which the user should respond or speak. In reply to the question or pause, the user may record a response via a camera (e.g., a webcam) and microphone, for example, built in to the user's terminal. The presentation may then continue for the remaining four minutes, in which questions and/or opportunistic pauses periodically occur and to which the user records responses. Once the presentation is completed, the user's recoded responses would then be associated with the video presentation at the respective times in the presentation when the user should respond.

In a further implementation, when a reviewer reviews the video presentation and the user's recorded responses, both the presentation and the user's responses are reproduced for the reviewer. In one embodiment, a split-screen or multiple windows showing the video presentation and synchronized recorded user responses are reproduced so that the review can assess, in quasi-realtime, how the user responded to the questions or opportunistic pauses in the video presentation. In another implementation, the system may automatically merge the video presentation and the user's recorded responses into one video presentation so that the reviewer can view the video presentation and user's responses on one screen or in one window. This implementation may be analogous to a television news interview in which the video shows a newscaster asking a question, and then, the camera “pans” to the interviewee, and the video shows the interviewee answering the question.

### 3. Submit Recorded Presentations for Review (FIG. 1 (Step 106)).

Once the user records his or her presentation, the application(s) may forward it to one or more trainers, employers, etc. for their review (FIG. 5 (step 506)). The application(s) may forward the actual presentation via email or may send an Internet link corresponding to presentation. Alternatively, the application(s) simply may send only a notification to the trainers, etc. prompting them to log onto a server or cloud storing the user's presentation. This email, link, or notification may be sent automatically to the trainers, etc. when the user finishes recording the presentation or may be sent only after the user instructs the application(s) to send it.

In addition, after the user selects the “Submit” button, the system or apparatus may forward the presentation to a predetermined set of recipients for review. For example, initially, the system may be configured to forward the recorded presentation to a default set of recipients based on a particular company's organization chart or information. In this example, the system may forward the presentation to the user's immediate supervisor and the people who are listed as the user's peers in the department in which the user works. However, often, an organizational chart or information for a company is not accurate, and in reality, the user works more closely with (and sometimes reports to) other company employees in other departments. Therefore, in one implementation, the default set of recipients of the user's recorded presentation can be adapted or customized so that the presentation is routed to the people that are in the best position to provide feedback for the user, such as the employees who truly are the user's peers and who actually supervise the user's work and development.

In addition to providing the presentation to an employer, supervisor, or manager, the application(s) may provide the presentation to one or more of the user's peers for review and comment.

In yet another implementation, the application may allow the user to specify one or more people to receive the email, link, or notification for the presentation.

When a trainer, employer, etc., reviews the user's video presentation, the presentation may be synchronized with the visual aids or other elements (e.g., PowerPoint presentation, script, outline, etc.). For instance, the software application may advance the PowerPoint presentation slides, pages of the script, or pages of the outline as they were advanced when the user recorded his or her video so that the trainer, employer, etc. can assess the user's timing with respect to the visual aids and other elements when the user practiced and recorded the presentation. Alternatively, the software program may automatically advance the visual aids or other elements or allow the trainer, employer, etc. to manually advance them similarly to manner described above.

### 4. Review Feedback (FIG. 1 (Step 108)).

After receiving the user's presentation, the application(s) may enable the trainer, manager, employer, peer etc. to critique and rate the user's presentation. This critique can include written narrative comments and/or a “multiple choice” ranking of “good,” “fair,” “needs improvement,” etc. in a number of various assessment categories. The feedback can also be in the form of various symbols, such as a ranking of “one star” through “five stars.” The categories can include, for instance, “oral communication,” “delivery,” “posture,” “confidence,” etc. In yet another example, the trainer, manager, employer, peer, etc. may record a video of himself or herself providing feedback to the user and even showing how the trainer, manager, employer, peer, etc. would conduct the presentation differently. Of course, instead of, or in addition to, creating a video, the trainer, etc. can provide feedback in the form of written comments.

Moreover, the feedback for a user's presentation may be provided to other users so that they also can benefit from the feedback. However, if all or some of the feedback is sensitive, or may be embarrassing for the user, it may only be provided to the user and not others or, alternatively, to the user and a subset of the others.

The application may allow the trainer, etc. to forward his or her ratings and comments to the user in a way that is similar to one of the above-described ways for forwarding the user's presentation to the trainer, etc. Then, the user can use the user terminal to view the ratings and comments to help the user further refine and improve the user's presentation skills. In light of this feedback, the user can record an improved presentation and submit it again for review. In this way, the training of the user is iterative and can be done efficiently and at times that are convenient to both the user and the trainer, etc.

In one embodiment, after the trainer or reviewer has reviewed the user's presentation and has forwarded it back to the user, the user can view the reviewer's ratings, comments, and feedback for the presentation by displaying the presentation in the playback screen 400 shown in FIG. 4. The reviewer's feedback may be included in the reviewer notes window 408. As explained above, some or all of the reviewer's notes and feedback may only be visible to the user who made the presentation and not to other users who have selected to view the presentation. Alternatively, the reviewer's feedback may be available to anyone viewing the presentation.

In addition, in some embodiments, the feedback may be more structured or formal. For example, the system may include various feedback templates or scorecards, and the reviewer may add to a relevant template or scorecard his or her constructive criticisms and/or rankings for various categories or topics relating to the user's presentation. For instance, the scorecard may list multiple criteria that the user should sufficiently master to achieve a certain rating for the presentation and may allow the reviewer to give more specific feedback based on the context.

In some implementations, the information or elements set forth on the scorecard or template (that the reviewer uses to review the user) are adapted or modified based on the user's profile or other user characteristics. For example, if the user has less experience in the area in which he or she is being reviewed, the scorecard or template may have fewer criteria and/or less complex criteria by which the reviewer assesses the user's performance. As the user gains more experience, continues to receive highly positive feedback from reviewers and/or peers, etc., the system may add additional and/or more complex elements to the scorecard or template.

In another embodiment, the current and prior scorecards, templates, and/or other feedback for a particular user may be appended or otherwise associated with one or more reviewed user presentations for a particular field or area. This information can used to assess the progress of the user, how efficiently he or she is being trained, and how well he or she is learning the relevant subject matter. If the user's training is progressing slower than desired, the system can use this information to adaptively and iteratively alter the training for the user until the user's training begins to progress at an acceptable rate.

In addition, feedback may be added as annotations to the user's recorded presentation at particular times of the presentation's reproduction so that the feedback is presented at, or otherwise associated with, the particular point in the presentation where the feedback was warranted. In this manner, when the user reviews his or her video and the feedback, he or she can more easily associate what aspects in the presentation prompted the feedback.

In addition, as feedback on how the user can improve his or her presentation, the reviewer may create a separate recording of the reviewer delivering the presentation. In one embodiment, while viewing the playback screen 400, the user can watch the reviewer's presentation in the video window 402 or in a separate window (not shown).

In some implementations, trainers, managers, employers, etc. may be able to track the user's activities on the system to determine how a user is progressing based on the feedback. Moreover, the trainers, managers, employers, etc. can also to determine how a user is supporting the progress of, and giving feedback to others, such as the user's peers or teammates on a sales team.

In addition, the system may be able to track how reviewers (e.g., trainers, reviewers, teachers, managers, coaches, etc.) interact with one or more users and review the material that users have submitted. For example, the system may assess how promptly and timely each reviewer responds to the users after receiving their submitted material. The system may also determine how thoroughly the reviewers review the users' presentations. For example, in one scenario, assume that the reviewers can provide feedback with a scorecard in which the reviewer can select both a pre-selected ranking (e.g., “Excellent,” “Good,” “Fair,” or “Poor”) for a particular element to be graded or assessed and can additionally provide a few sentences of written feedback for the element. The system may keep track of whether the reviewer selects just the pre-selected ranking for feedback or if the reviewer additionally takes more time and thought to prepare the written feedback. In some embodiments, if the reviewer habitually provides only pre-selected feedback, the system may prompt the reviewer to provide more detailed written feedback so that the users can receive more constructive criticism and learn how to improve more quickly. The system can also analyze the reviewers' feedback to recommend other improvements for them so that they can provide better feedback and coaching in the future.

A higher-level employer or manager can also review the feedback that the trainers, managers, and lower-level employers are providing to various users to ensure that the users are, in fact, receiving high-quality feedback and being trained well. The higher-level employer or manager can log onto the system to view the prerecorded feedback and written comments at his or her convenience. Alternatively, the feedback can be forwarded to the higher-level employer when it is sent to a user or can be forwarded to the higher-level employer at predetermined or specified intervals.

In another embodiment, and as alluded to above, the user can provide comments to his or her peers in a company and vice versa. For example, the user may be a newly hired sales representative for a company who is in a class with 14 other newly hired sales representatives. The user may be able to provide feedback on the presentations of the 14 other representatives in his or her class, and the other people in his or her class may be able to provide feedback to the user. Moreover, the user may be able to use the application(s) to send a message to one or more of the 14 other representatives to specifically solicit feedback. As a result, the user is able to solicit and receive informal feedback on his or her presentation and improve the presentation based on this feedback before submitting his or her presentation to the user's employer or trainer for formal feedback. Of course, the user may also send a message to his or her employer or manager to solicit feedback.

In some implementations, the user may be able to solicit or otherwise receive feedback or rankings for his or her presentation from a group of multiple reviewers (e.g., other users, trainers, managers, etc.). In one non-limiting scenario, the feedback or rankings may be averaged together and provided to the user. This average may be provided to the user with or without the individual feedback and rankings from each of the reviewers in the group. Moreover, the averaged feedback or rankings may be a weighted average in which more weight is given to the feedback or rankings more senior employees, managers, etc. than to the feedback or rankings of more junior employers, other users who are peers of the user being reviewed, etc. Moreover, in one example, a user may need to receive a predetermined minimum ranking on a feedback before becoming “certified” for a presentation or a particular element of the presentation. In this example, the user may become certified if the average ranking from the group of reviewers exceeds the predetermined minimum ranking.

In some embodiments, the feedback or ranking of one or more user's presentation may be published (e.g., electronically on the system) or otherwise made available for other users to see. These published rankings may also include comparisons of the user's results and rankings with the results and rankings of their peers. Moreover, these results and rankings may be presented as a “leaderboard-type” report, which lists each user and his or her score from highest ranking to lowest ranking.

Returning to the playback page 400 of FIG. 4, comments may be shown in a comments window 410, which in some embodiments may increase the length of the window or implement a scrolling feature to accommodate multiple comments. Comments may be handled by any method known in the art. For example, subsequent comments may be made as replies to existing comments and displayed accordingly. An administrator may be able to review comments before allowing them to be posted and/or may be able to remove or edit comments which are not considered helpful to the training process.

In a further embodiment, the application(s) may require the user to receive a certain amount of positive feedback from his or her peers (e.g., the 14 other newly hired representatives) before allowing the user to submit the presentation to an employer, manager, or trainer for review. For example, the “certain amount of feedback” may include a certain number or percentages of “yeses,” “likes,” “approves,” or “certification readies” from his or her peers or others. Requiring peer or other approval of the presentation before it is supplied to an employer or supervisor helps to ensure that the user has practiced the presentation and that the presentation is sufficiently refined before the user's employer or trainer reviews it. This “pre-approval” process helps to prevent the employer or trainer from wasting time reviewing presentations that have not been adequately rehearsed.

In yet another implementation, the application(s) may allow the user to rank the feedback of his or her peers, employer, manager, trainer, etc. This “upward evaluation” of the feedback has a tendency to encourage people providing feedback on others' presentations to be more thoughtful, thorough, and constructive in their comments about the presentations and suggestions for improvement.

### Description of Included Documents

Additional details and descriptions of various non-limiting embodiments of the present disclosure can be found in Attachments A to N, which are incorporated into the present disclosure by reference. While the present disclosure (including the attachments) is described in conjunction with particular embodiments, the embodiments are merely examples and are not intended to limit the inventive concepts set forth herein. One of ordinary skill in the art, upon reading the present disclosure, will readily understand that additional implementations, modifications, and embodiments, as well as other fields of use, are within the scope of the inventive concepts.

Brief descriptions of Attachments A to N are provided below.

### Attachment A

Attachment A provides an overview of non-limiting problems with traditional sales training techniques. The attachment also describes a non-limiting embodiment of the present disclosure, referred to as the “Chaplin” platform, which addresses one or more of these problems.

### Attachment B

Attachment B is a presentation showing various aspects of an illustrative, non-limiting embodiment of the present disclosure. This embodiment is also referred to as “Chaplin” in the presentation and is used to train salespeople in a particular company.

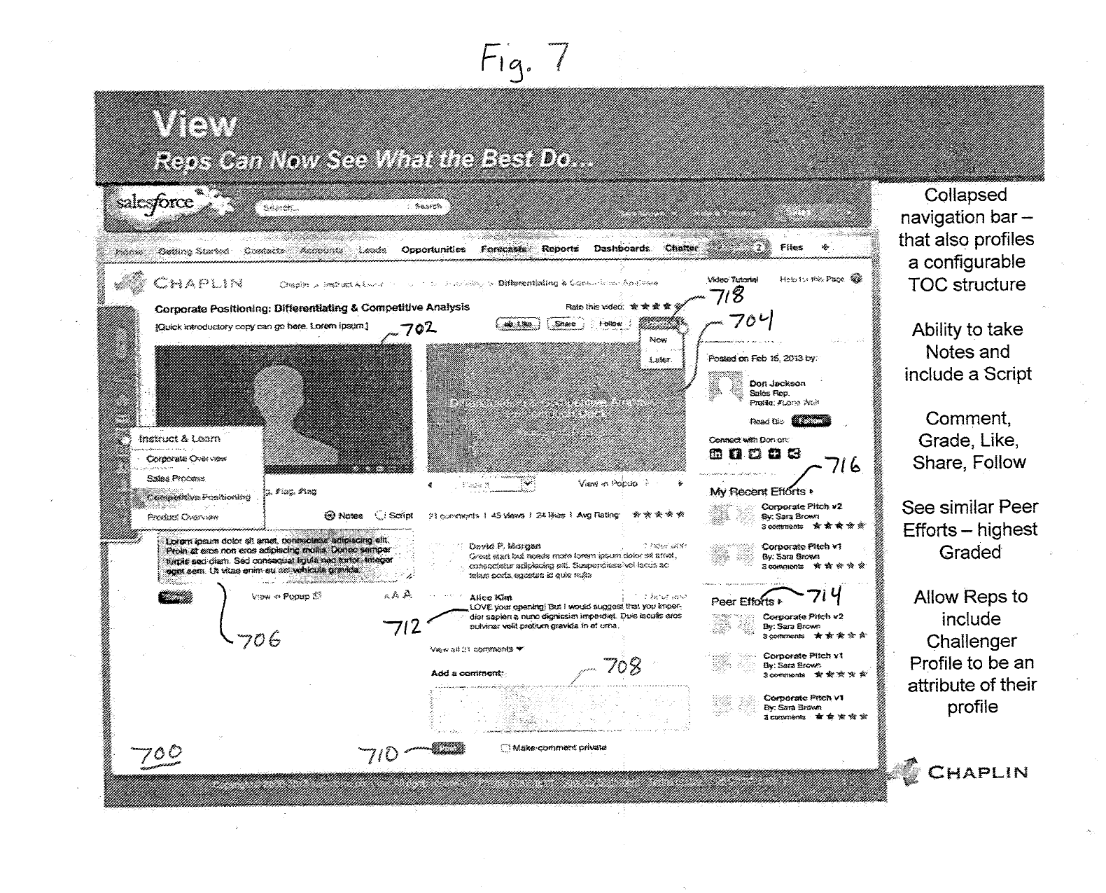

Slide 4 of the presentation is entitled “View” (reproduced as FIG. 7 of the present disclosure) and shows an example of a playback screen 700 displayed on a user terminal when a user, or “sales rep,” (i.e., “Sara Brown”) is viewing a sample presentation from either an expert who is who is skilled at giving the presentation or another user. This screen 700 is, in some respects, a more detailed, non-limiting example of the playback screen 400 shown in FIG. 4.

Similar to the playback screen 400, the playback screen 700 contains a video window 702, a presentation window 704, a notes/script window 706, and a comment window 708. The video window 702 contains the video (and audio) recording of the person delivering the presentation. The presentation window 704 contains a visual aid (e.g., a set of PowerPoint slides entitled “Differentiating & Competitive Analysis Presentation Deck”) to accompany the presentation. The notes/script window 706 contains notes accompanying the presentation. Moreover, as shown in FIG. 7, there are a notes radio button and a script radio button above the window 706, and Sara can selectively display the presentation notes or the presentation script in the window 706 by selecting the appropriate radio button.

The comment window 708 allows Sara to enter her comments relating to the presentation, and she can select the post button 710 to post her comments in a comment area 712 accompanying the presentation. As shown, comments from other users and/or reviewers are included in the comments area 712. Moreover, if Sara would like to privately comment on the user's presentation so that other users (besides the user who delivered the presentation) cannot see the comment, Sara can select the “Make Comment Private” option below the comment window 708 before selecting the post button 710 to post her comment.

The screen 700 also includes a “peer efforts” area 714, which lists presentations that Sara's peers recorded for the same or similar topic. In one implementation, the peer presentations listed in the area 714 are presentations by Sara's peers that received the best reviews, rankings, and/or comments from their reviewers and/or from other peers. Sara can select one of these peer presentations in the “peer efforts” area 714 to review the presentation in the playback screen 700.

When Sara has recorded a presentation, submitted it for review, and received the feedback for her reviewed presentation from her reviewer, she can select the reviewed presentation and similarly display it in the playback screen 700. In one embodiment, when Sara reviews her own presentation in the playback screen 700, the screen includes a “my recent efforts” area 716 which lists prior presentations that Sara recorded and that were reviewed and ranked by one or more reviewers. In one implementation, the presentations listed in the area 716 are prior attempts at recording the same presentation that Sara is currently reviewing in the playback screen 700.

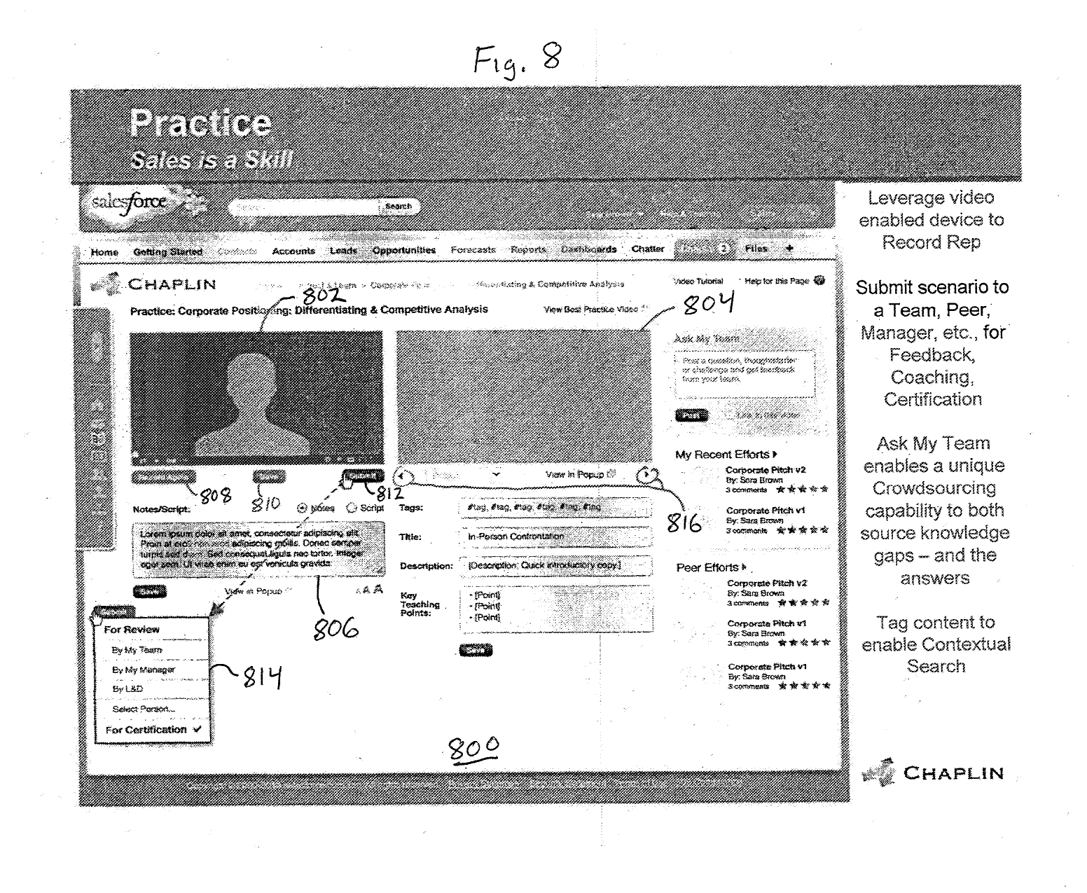

If Sara would like to practice delivering and/or recording the presentation again, she can select the “practice” button 718 in the playback screen 400. After selecting the button 718, the practice screen 800 shown in slide 5 of the presentation, entitled “Practice,” in Attachment B is displayed. This practice screen 800 is reproduced as FIG. 8 of the present disclosure and, in some respects, is a more detailed, non-limiting example of the recording screen 600 shown in FIG. 6.

When this practice screen 800 is displayed, Sara can practice and record a presentation. As shown, the screen 800 includes a recording window 802, a visual aid window 804, and a notes/script window 806. Similar to the recording screen 600 in FIG. 6, the recording screen 800 in FIG. 8 allows Sara to record her presentation by selecting the “record again” button 808, save her presentation by selecting the “save” button 810, and submit her presentation for review by selecting the “submit” button 812.

In one embodiment, after selecting the “submit” button 812, Sara can choose who she would like to review the recorded presentation. For example, as shown, after selecting the button 812, a pop-up menu 814 appears that allows Sara to choose her team, manager, or others to review the presentation. Once Sara chooses the desired reviewer, the presentation is delivered to the reviewer as described above.

In another example, from the pop-up menu 814, Sara can choose to have her presentation reviewed “for certification.” When this option is selected, the presentation is submitted to be reviewed by a person who has the authority to determine if Sara has become sufficiently proficient in one or more areas to be “certified.” As an example, a sales representative may need to demonstrate that he or she has mastered certain aspects of the presentation before he or she can go on a “sales pitch” without being accompanied by a supervisor or more senior sales representative. For instance, in Sara's case, the “certifying reviewer” may review her presentation to determine if she has mastered her delivery of the presentation, knowledge of the product or service she is trying to sell, has the correct posture and demeanor, has the appropriate pauses and pacing, in her delivery, etc. As another example, an employee may need to demonstrate that he or she is proficient in certain skills and understanding before he or she is eligible to be “certified” for a promotion.

The visual aid window 804 and the notes/script window 806 shown in FIG. 8 operate similarly to the windows 704 and 706 shown in FIG. 7 and to the visual aid windows 606 and 610 shown in FIG. 6. Moreover, the previous and next arrows 816 are located below the visual aid window 804 and allow Sara to manually advance or reverse one or more visual aids (e.g., PowerPoint slides, a script, and/or an outline) accompanying the presentation as described above.

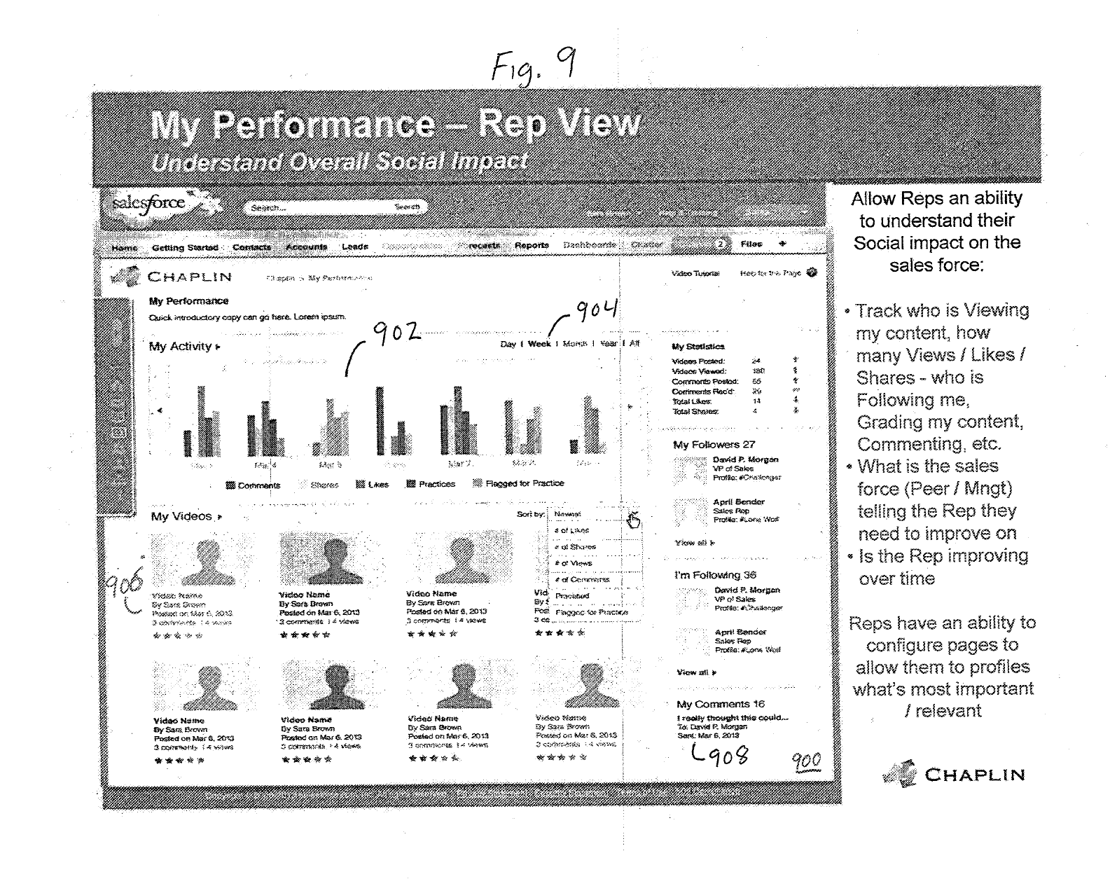

Slide 6 of Attachment B is entitled “My Performance—Rep View” (reproduced as FIG. 9 of the present disclosure) and shows a non-limiting example of a summary screen 900 displayed on Sara's user terminal. This screen 900 shows a snapshot of the Sara's performance on her presentations, who has reviewed and commented on her presentations, and how others have ranked her presentations. As shown in FIG. 9, in one embodiment, the summary screen contains an area 902 that shows Sara's performance over time. In one implementation, the area contains bar graphs that indicate how many people have commented on, “liked,” etc. Sara's presentations during certain instances over the course of a certain period of time. The example in FIG. 9 shows this information for each day of the past week, and the period of time over which this information is displayed can be changed by selecting the “day,” “week,” “month,” or “year” notation in the area 904.

The summary screen 900 also contains an area 906 showing the various presentation videos that Sara has recorded and submitted for review, along with the average rank (e.g., one star to five stars) that others have given to the videos and links to the comments that others made on each video. In addition, the screen 900 also contains an area 908 in which all of the comments to Sara's videos can be selected and viewed.

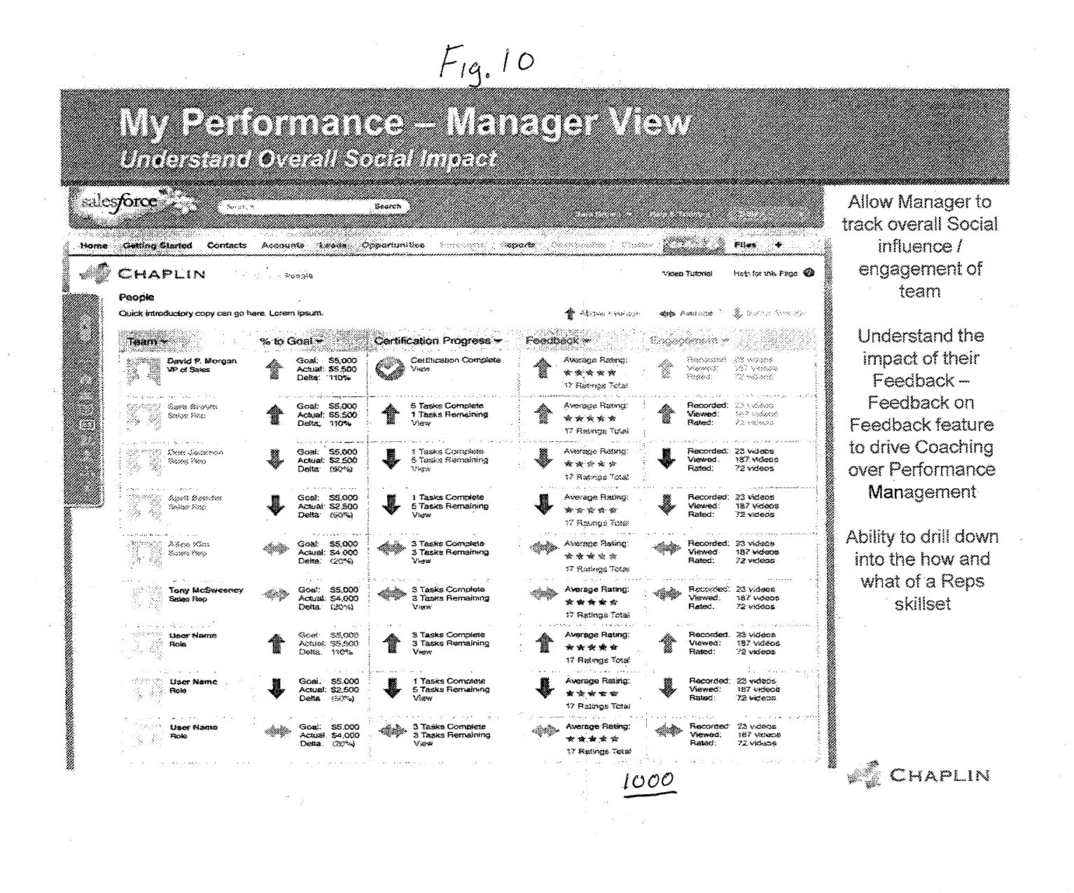

Slide 7 is entitled “My Performance—Manager View” (reproduced as FIG. 10 of the present disclosure) and is a non-limiting example of a summary screen 1000 that a manger, supervisor, or reviewer can display on his or her terminal. For instance, a manager, who is reviewing the recorded presentations of Sara Brown, as well as several other users, can monitor the sales performances of the users, how many sales training presentations (e.g., videos) the users have viewed, recorded, and rated, and the average rating that the users have received from others for their recorded presentations. With this information, the manager can more easily recommend additional training for Sara and the other users to help them improve their skills and sales performance.

### Attachment C

Attachment C is a presentation showing various aspects of examples of problems with traditional training techniques. The presentation also shows an illustrative, non-limiting embodiment of the present disclosure that can overcome these problems.

For example, slide 2 of the presentation shows various statistics highlighting problems with the traditional training techniques. Slide 5 shows how the embodiment follows a “view,” “record,” “submit,” and “refine” methodology for training users of the application(s). Namely, as described above, a user can “view” a presentation performed by someone skilled in the field. Then, the user can “record” his or her own presentation and “submit” it for feedback from his or her employers, peers, etc. After receiving the feedback, the user can “refine” his skills.

Slides 6 to 11 shows various platform features of the non-limiting embodiment. These features include video and audio features, social features, and user interface features. For example, slides 6 and 7 of Attachment C show a practice screen which is similar to the recording screen 600 and the practice screen 800 shown in FIGS. 6 and 8 and discussed above.

This embodiment is referred to as “CommercialTribe” in the presentation and is used to train salespeople in a particular company.

### Attachment D

Attachment D provides an overview of non-limiting problems with traditional training techniques. The attachment also describes non-limiting embodiments of the present disclosure that can overcome these problems.

### Attachment E

Attachment E illustrates specific, non-limiting examples of “user stories,” which set forth detailed examples of how different users interact with one or more software application(s) in accordance with embodiments of the present disclosure. These embodiments refer to the software application(s) as “Chaplin,” which is used by a Product and Services company. The user stories relate to three user profiles: (1) “Sara,” who is a newly hired sales representative, (2) “Bill,” who is an experienced representative with the company, and (3) “Pat,” who is a sales manager for the company.

### Attachment F

Attachment F contains illustrative examples of a site map and various features and functions of embodiments of the present disclosure.

### Attachment G

Attachment G contains illustrative examples of a site map and various features and functions of embodiments of the present disclosure.

### Attachment H

Attachment H illustrates a non-limiting example of the structure of a training website in accordance with embodiments of the present disclosure.

### Attachment I

Attachment I shows illustrative examples of the layout of a user interface display when embodiments of the present disclosure are performing various functions and operations. Specifically, in Attachment I:
Page 1 is an example of the layout of a Login Page.
Page 2 is an example of the layout of a Home (or Main) Page.
Page 3 is an example of the layout of a Playback Screen, such as the playback screens 400 and 700 shown in FIGS. 4 and 7.
Page 4 is an example of the layout of a Recording Screen, such as the recording screen 600 and the practice screen 800 shown in FIGS. 6 and 8.
Page 5 is an example of the layout of a Managing Screen that enables a manager to review and rate presentations of others.
Page 6 is another example of the layout of a Recording Screen, such as the recording screen 600 and the practice screen 800 shown in FIGS. 6 and 8.
Pages 7-11 are examples of a Search Page, such as the search screen 300 shown in FIG. 3.

### Attachment J

Attachment J shows an example of various software layers of a non-limiting embodiment of the present disclosure.

### Attachment K

Attachment K illustrates a specific, non-limiting example of how different users interact with one or more software application(s) in accordance with embodiments of the present disclosure. In this example, a newly hired salesperson, named “Jonathan,” and a manager, named “Paul,” utilize the software application(s). This embodiment is referred to as “CommercialTribe” in the attachment and is used to train salespeople in a particular company.

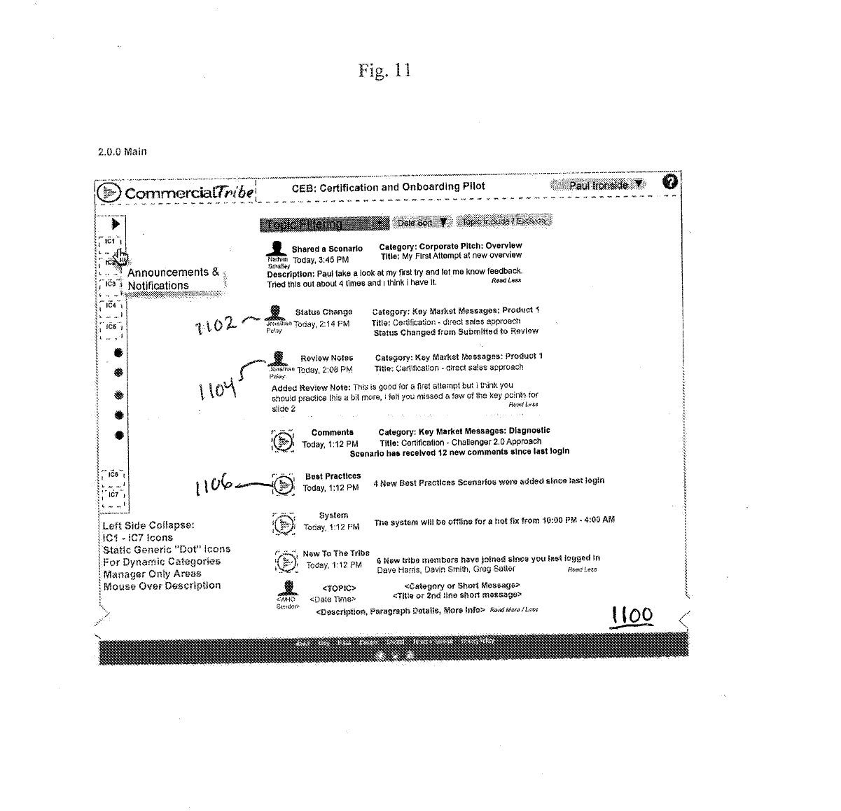

As explained on page one of the attachment, when Jonathan initially logs onto the system, an Announcements and Notifications page 1100 is displayed (and reproduced as FIG. 11 of the present disclosure). Jonathan previously submitted a video of a sales pitch (entitled “Certification—Direct Sales Approach) to Paul with the goal of having Paul “certify” that Jonathan has sufficiently mastered one or more elements of delivering the pitch. In this embodiment, an element of Jonathan's sales pitch is certified when the manager, Paul, reviews a video of Jonathan delivering the sales pitch and believes that the element was delivered with a certain degree or proficiency or skill.

As shown by the status change notation 1102 on the page 1100, the status of the video that Jonathan has submitted to Paul has been changed from “Submitted” to “Review,” which indicates that Paul has reviewed, or is in the process of reviewing, the video. In addition, during the review process, Paul has provided feedback to Jonathan about his recorded sales pitch. Specifically, in the review notes area 1104, Paul has commented that Jonathan's video was a good first attempt, but that he still needs to practice the pitch a bit more before his sales pitch is “certified.”

The Announcements and Notifications page 1100 also indicates that four new “best practices scenarios” have been added to the best practices folder 1106. In one embodiment, a “best practice scenario” or “video” is a video of a sales pitch from a manager, trainer, or other salesperson that has already been performed with the requisite skill or proficiency. In a further implementation, a “best practice video” is one that has been “certified” by a manager, trainer, or higher-level employee. In yet another embodiment, a best practice scenario is a “model” sales pitch or other presentation from an expert or well-regarded person in in the field or a sales pitch from a user that has received excellent feedback from a manager, trainer, or higher-level employee. Of course, the “best practice videos” are not limited to the types of “best practices videos” described above and can include a combination of the different types of “best practices videos.”

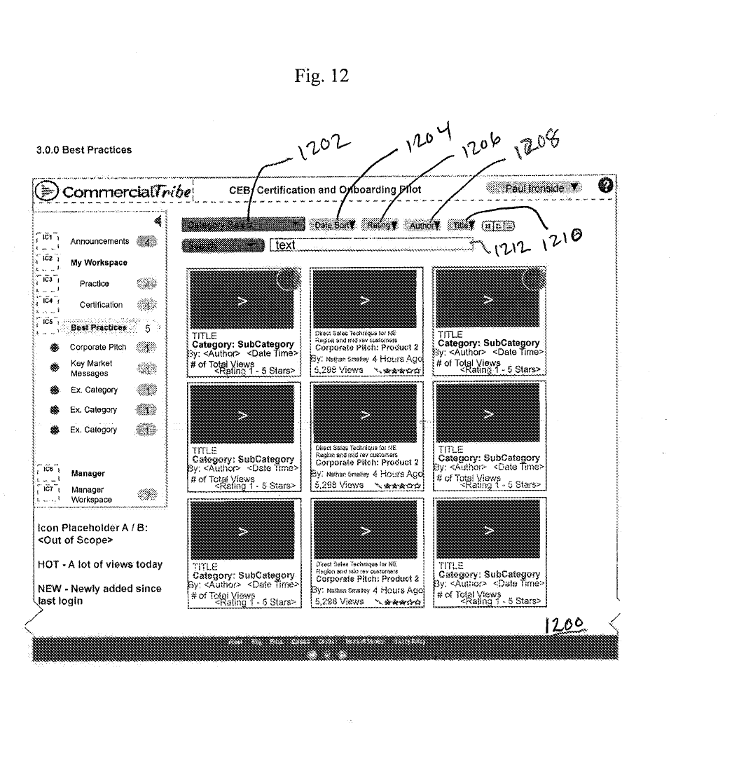

When Jonathan selects the best practices folder or icon 1106, the “Best Practices Page” 1200 shown on page two of the attachment (and reproduced as FIG. 12 of the present disclosure) is displayed. Jonathan can choose the category dropdown box 1202 to sort the best practices videos or presentations by category and sub-category to find an appropriate video sales pitch to review, study, and better hone his skills. In addition to the category dropdown box 1202, there are other dropdown boxes 1204, 1206, 1208, and 1210 that Jonathan can use to alternatively sort the best practices videos and presentations by date, rating, author, and title, respectively. Also, Jonathan can enter keywords or a Boolean search string into a search box 1212 to search for particular videos and presentations.

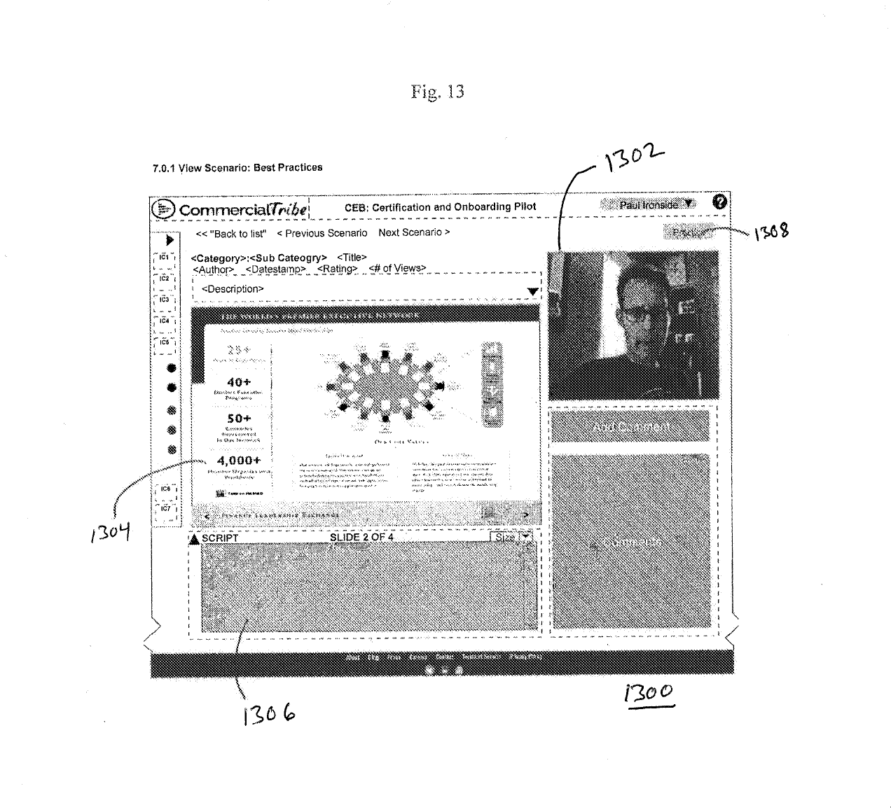

In the current example, Jonathan selects three “best practices videos” to review. The first video was created by Paul, and the second and third videos were created by other managers. When Jonathan selects one of the videos (e.g., Paul's video) to review, a Playback Page 1300 shown one page three of Attachment K (and reproduced as FIG. 13 of the present disclosure) is displayed. This Playback Page 1300 is similar to the playback screens 400 and 700 described above in conjunction with FIGS. 4 and 7.

Once the Playback Page 1300 is displayed, Jonathan can review Paul's recorded sales pitch. Namely, the video recording of Paul delivering the sales pitch is shown in a video window 1302, and PowerPoint slides are displayed in synchronization with the sales pitch delivery in the presentation window 1304. In addition, the script or outline that Paul used while delivering the sales pitch may also be displayed in a script window 1306 along with the sales pitch.

After reviewing Paul's “best practice video” a few times, he may select the “practice” button 1308 on the upper right portion of the page 1300 to record himself presenting the pitch.

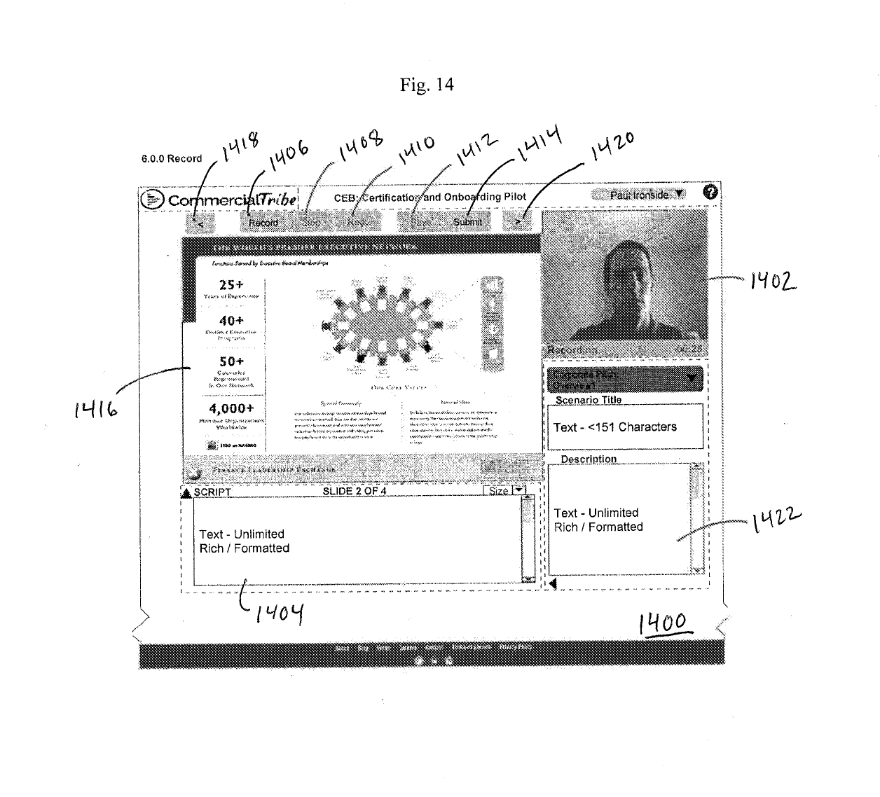

When Jonathan selects the “practice” button 1308, a Record Page 1400 shown one page four of Attachment K (and reproduced as FIG. 14 of the present disclosure) is displayed. This Record Page 1400 is similar to the recording screen 600 and the practice screen 800 described above in conjunction with FIGS. 6 and 8.

As shown in FIG. 14, the Record Page 1400 includes a recording window 1402 that shows the video images of Jonathan delivering the presentation as he is presenting it and as the video images are being recorded. Moreover, as explained on pages four and five of Attachment K, Jonathan can edit and rewrite portions of a script for the sales pitch presentation, which is displayed in a script window 1404 in the lower left portion of the screen 1400 while he records himself practicing the pitch. As shown on the top of the screen, the application displays “record,” “stop,” “redo,” “save,” and “submit” buttons 1406, 1408, 1410, 1412, and 1414. Jonathan can select the “record” button 1406 to start or resume a recording of his pitch and can select the “stop” button 1408 to stop the recording. He can select the “redo” button 1410 to start recording his presentation over from the beginning, and can select the “save” button 1412 to save the current version of his recorded presentation so that he can resume recording it, or view it, at a later date or time.

Also, as shown in FIG. 14, Jonathan uploaded PowerPoint slides into a visual aid window 1416 to use during his sales pitch. In this embodiment, the Record Page 1400 also has “Previous” and “Next” buttons 1418 and 1420, which enable Jonathan to page manually through the slides and/or script as he delivers his presentation.

When Jonathan is pleased with his recorded sales pitch video, he can select the “submit” button 1414 to send the video to his manager, Paul, for review. Moreover, as explained on page four of Attachment K, Jonathan can also append, to his submitted video, a message for Paul in a description window 1422. In this example, the message states “I know I still need to work on my pace. Did I use dramatic pauses effectively this time around?”

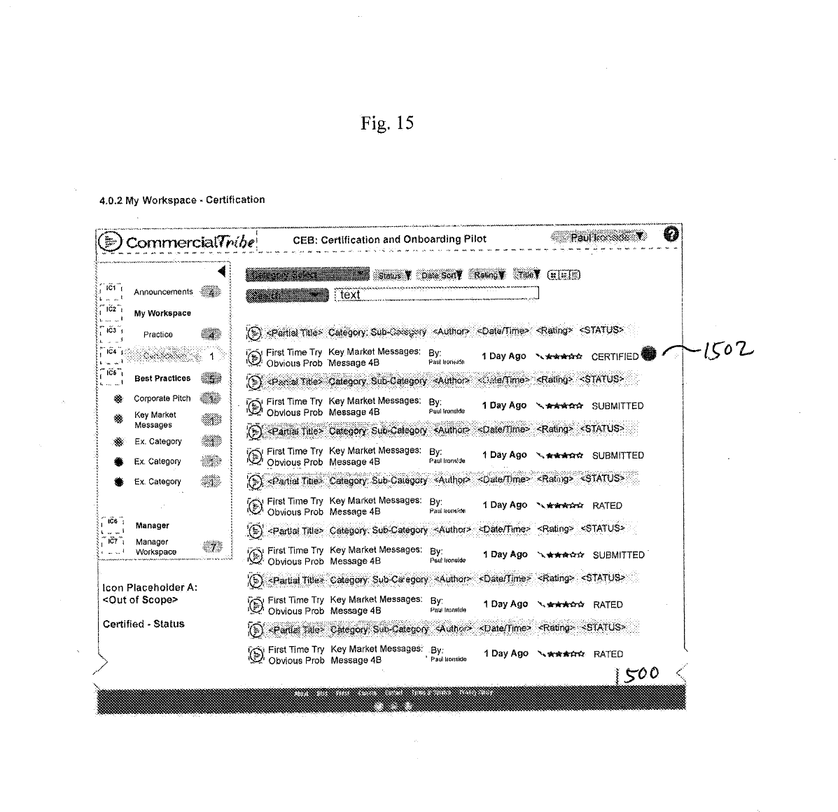

As shown and described on page five of Attachment K, after Jonathan submits his sales pitch video, one or more other people can rate his video. These ratings are displayed on Jonathan's “My Workspace” page 1500 shown in the attachment (and reproduced as FIG. 15 of the present disclosure). Moreover, this page 1500 indicates whether one or more of the sales pitches that he has previously submitted for review have been “certified” by another (e.g., by the manager, Paul). For example, as shown on the page 1500, one of the sales pitches 1502 has been certified.

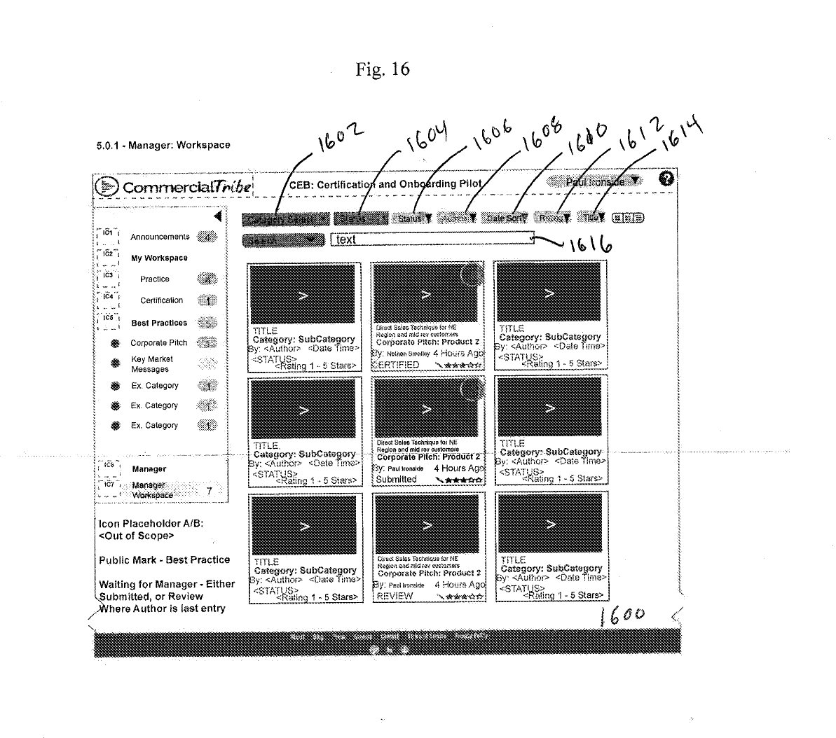

Pages six and seven of Attachment K describe how Paul, Jonathan's manager, can access the application(s) to view Jonathan's sales pitch video, as well as the videos of others. In this embodiment, when Paul logs onto the system, he can display his Manager Workspace Page 1600 shown on page six (and reproduced as FIG. 16 of the present disclosure). This page 1600 shows several videos that his sales team submitted for his review (including Jonathan's video). As in the case of the Best Practices Page 1200 shown in FIG. 12, Paul can manipulate various dropdown boxes 1602, 1604, 1606, 1608, 1610, 1612, and 1614 to sort the submitted presentations by category, status, author, date, rating, and title, respectively. In addition, Paul can enter keywords or a Boolean search string into a search box 1616 to search for particular videos and presentations.

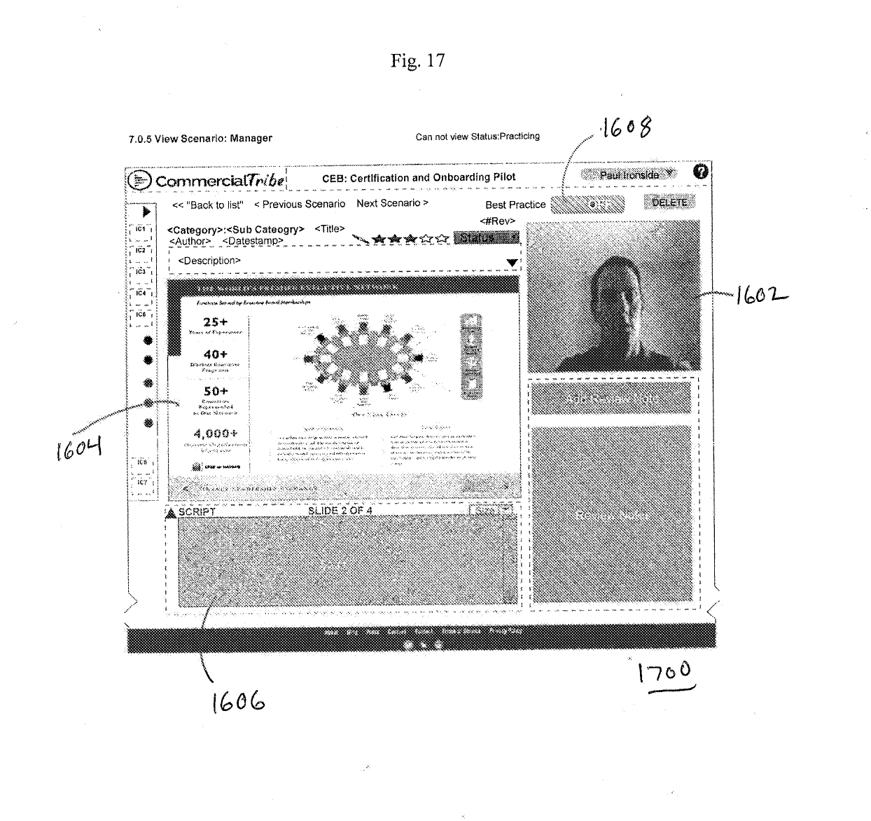

Once Paul selects Jonathan's sales pitch video, a Playback Page 1700 is displayed so that Paul can view the video. The Playback Page 1700 is shown on page seven of the attachment (reproduced as FIG. 17 of the present disclosure) and is similar to the Playback Page 1300 shown in FIG. 13 and described above. As illustrated, the video recording of Jonathan delivering the sales pitch is shown in a video window 1602, and PowerPoint slides are displayed along with the sales pitch in the presentation window 1604. If Jonathan submitted a script or outline with his sales pitch video, it is displayed in a script window 1606.

After viewing Jonathan's video, Paul can rate sales pitch. If the sales pitch is a good enough to be an exemplary sales pitch for others to model, Paul can make Jonathan's video a “best practices video” by toggling the “best practices” button 1608 in the upper right portion of his screen. Moreover, Paul can “certify” one or more elements of the sales pitch (or the entire sales pitch) if the quality of the element(s) or pitch is sufficiently high. Namely, if Paul feels that Jonathan has the requisite skill for the element(s) of the pitch, Paul can certify it by inputting a “certify” command. This certify command can be input by, for example, selecting a “certify” button or icon on his user interface or ranking the presentation with a sufficiently high rank.

### Attachment L

Attachment L shows a non-limiting embodiment of the technical architecture of a software platform for the applications(s) according to the present disclosure.

### Attachment M

Attachment M contains illustrative examples of various specifications and features of the software application(s) according to the present disclosure.

### Attachment N

Attachment M contains illustrative examples of various specifications and features of an embodiment according to the present disclosure.

### CONCLUSION

The examples of the software application(s), sales training techniques, and tools of the present disclosure involve processing input data and generating output data. This input data processing and output data generation may be implemented in hardware or software. For example, specific electronic components may be employed in a web server or similar or related circuitry for implementing the functions associated with the application(s) and training tools. Alternatively, one or more processors operating in accordance with instructions may implement the functions. In this case, the instructions of the software application(s) and/or other instructions may be stored on one or more non-transitory processor readable storage media (e.g., a magnetic disk, solid state memory device, optical storage medium, or other storage medium) or may transmitted to one or more processors via one or more signals embodied in one or more carrier waves transmitted along one or more wired or wireless connections. Moreover, the processing of the instructions may be performed by one processor or distributed over multiple processors.

The present disclosure is not limited in scope by the specific embodiments described above and set forth in Attachments A to N. Indeed, other embodiments of, and modifications to, the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

1. A computer-implemented method for online training, comprising:
presenting to a first user a plurality of exemplary recorded presentations;
recording a presentation by the first user;
presenting to a second user the recorded presentation by the first user;
receiving feedback from the second user on the recorded presentation by the first user; and
presenting the feedback to the first user.

2. A system comprising:
one or more processors communicatively coupled to a network, wherein the one or more processors are configured to:
present to a first user a plurality of exemplary recorded presentations;
record a presentation by the first user;
present to a second user the recorded presentation by the first user;
receive feedback from the second user on the recorded presentation by the first user; and
present the feedback to the first user.

3. An article of manufacture comprising:
at least one processor-readable non-transitory storage medium; and
instructions stored on the at least one medium;
wherein the instructions are configured to be readable from the at least one medium by at least one processor and thereby cause the at least one processor to operate so as to:
present to a first user a plurality of exemplary recorded presentations;
record a presentation by the first user;
present to a second user the recorded presentation by the first user;
receive feedback from the second user on the recorded presentation by the first user; and
present the feedback to the first user.
